(19) United States
(12) Patent Application Publication
(10) Pub. No.: US 2018/0278091 A1
(43) Pub. Date: Sep. 27, 2018

(54) COMMUNICATION SYSTEM, COMMUNICATION APPARATUS, METHOD OF CONTROLLING THE COMMUNICATION APPARATUS, AND PROGRAM

(71) Applicants: Kazunori FUKASAWA, Tokyo (JP); Takeshi SUETSUGU, Tokyo (JP); Yasuhiro SENDA, Tokyo (JP); Yiling YE, Tokyo (JP)

(72) Inventors: Kazunori FUKASAWA, Tokyo (JP); Takeshi SUETSUGU, Tokyo (JP); Yasuhiro SENDA, Tokyo (JP); Yiling YE, Tokyo (JP)

(21) Appl. No.: 15/524,357

(22) PCT Filed: Nov. 5, 2015
(86) PCT No.: PCT/JP2015/081126

§ 371 Date: May 4, 2017

(30) Foreign Application Priority Data
Nov. 7, 2014 (JP) 2014-226995

(51) Int. Cl. H02J 13/00; G05B 15/02

(52) U.S. Cl. CPC H02J 13/0017; G05B 15/02

(57) ABSTRACT

A communication apparatus including a reception unit that receives a measurement value related to an amount of electric power, which is periodically transmitted to a first destination through a first pathway from an electric power meter through a second pathway that is different from the first pathway, and a transfer unit that transfers the received measurement value to a second destination that is different from the first destination, through a third pathway that is different from the second pathway.

### CROSS-REFERENCE TO RELATED PATENT APPLICATIONS

This application is a National Stage Entry of International Application No. PCT/JP2015/081126, filed Nov. 5, 2015, which claims priority from Japanese Patent Application No. 2014-226995, filed Nov. 7, 2014. The entire contents of the above-referenced applications are expressly incorporated, herein by reference.

### TECHNICAL FIELD

The present invention relates to a communication system, a communication apparatus, a method of controlling the communication apparatus, and a program.

### BACKGROUND ART

An example of an electric power information provision system for providing electric power information to electric power consumers to achieve timely energy conservation on the electric power consumer side is disclosed in Patent Document 1. In the electric power information provision system of Patent Document 1, a communication terminal provided for each electric power consumer transmits electric power information including electric power amounts measured by an electric power meter connected to a communication apparatus to an automatic meter-reading server and predicts a demand value at a demand time-limit by integrating the electric power amounts measured by the electric power meter. The communication terminal transmits demand information indicating a relationship between the predicted demand value at the demand time-limit and a target demand value that is set in advance, and the electric power information that includes the amount of electric power measured by the electric power meter, to a service provision processing terminal. Furthermore, the communication terminal performs communication with a specific scale electric power supplier's terminal (Poser Producer and Supplier (PPS) terminal) through the Internet, by way of a user terminal, and provides electric power information to the PPS terminal according to a request from the PPS terminal.

### RELATED DOCUMENT

### Patent Document

[Patent Document 1] Japanese Patent Application Publication No. 2007-6579

### SUMMARY OF THE INVENTION

### Technical Problem

As disclosed in Patent Document 1, in recent years, it has become possible to provide a service for transmitting an amount of electric power to a Home Energy Management System (HEMS) terminal using a communication function of the electric power meter or a so-called smartphone to display the amount of electric power on an In-Home Display (IHD).

Incidentally, at the present, electric power retailers other than electric power companies are able to acquire information on an amount of electric power-consumption consumed by each consumer approximately one or plural times a day from the electric power company, but cannot collect the information in real time.

It is also disclosed in Patent Document. 1 that in response to a request from the PPS terminal, the amount of electric power is transmitted from the user terminal, but generally, communication with the PPS terminal is through the Internet, so that in actuality, the user terminal connects to the Internet through a communication apparatus, such as a router or an access point to communicate with the PPS terminal. Thus, when the communication apparatus such as the router is not powered on, communication cannot be performed between the user terminal and the PPS terminal, preventing an information, request from the PPS terminal from reaching the user terminal. This causes a problem in that the PPS terminal cannot collect the information. More precisely, there is a problem in that a measurement value related to the amount of electric power cannot be collected in real time.

An object of the present invention, which was made in view of the state described above, is to provide a communication system, a communication apparatus, a method of controlling the communication apparatus, and a program, in all of which a measurement value related to an amount of electric power can be collected in real time.

### SOLUTION TO PROBLEM

According to aspects of the present invention, the following configurations are employed in order to solve the problem described above.

A first aspect relates to a communication apparatus.

According to the first aspect, there is provided a communication apparatus including a reception unit that receives a measurement value related to an amount of electric power, which is periodically transmitted to a first destination through a first pathway, from an electric power meter through a second pathway that is different from the first pathway, and a transfer unit that transfers the received measurement value to a second destination that is different from the first destination, through a third pathway that is different from the first pathway and the second pathway.

A second aspect relates to a communication system.

According to the second aspect, there is provided a communication system including a communication apparatus and a server, in which the communication apparatus includes a reception unit that receives a measurement value related to an amount of electric: power, which, is periodically transmitted to a first destination through a first pathway, from an electric power meter through a second pathway that is different from the first, pathway, and a transfer unit that transfers the received measurement value to the server that is a second destination which is different, from the first destination, through a third pathway that is different from the second pathway, and in which the server includes information a collection unit that collects the measurement value of the electric power meter, which is transferred from at least one communication apparatus.

A third aspect relates to a method of controlling a communication apparatus, which is performed, by at least one computer.

According to the third aspect, there is provided a method of controlling a communication apparatus, performed, by the communication apparatus, including: receiving a measurement value related to an amount of electric power, which is periodically transmitted to a first destination through a first pathway, from an electric power meter through a second pathway that is different from the first pathway; and transferring the received measurement value to a second destination that is different from the first destination, through a third pathway that is different from the second pathway.

Note that, another aspect of the present invention may be a program for causing at least one computer to perform the method according to the third, aspect or a computer-readable recording medium on which the program is recorded. The recording media include a non-transitory physical medium.

The computer program includes computer program codes that, when executed by the computer, cause the computer to perform the method of controlling a communication apparatus, on the communication apparatus.

Additionally, still another aspect of the present invention relates to a second communication apparatus.

According to the aspect of the present invention, there is provided a second communication apparatus including: an authentication information acquisition unit that acquires information for authenticating an electric power meter based on identification information of the own apparatus, an authentication unit that performs authenticated connection to the electric power meter based on the authentication information; a reception unit that receives a measurement value related to an amount of electric power from the electric power meter, and a transfer unit that transfers the measurement value received from the electric power meter, to a destination that is different front the electric power meter.

Note that arbitrary combinations of constituent elements described above, and results of exchanging expressions employed in the present invent ion among the method, the apparatus, the system, the recording medium, the computer program, and the like are effective as aspects of the present invention.

Furthermore, various constituent elements according to the present invention do not necessarily need, to be individually present independently of one another. Plural constituent elements may be formed as one member, one constituent element may be formed as plural members, a certain constituent element may be one portion of another constituent element, one portion of a certain constituent element and one portion of another constituent element may overlap, and so forth.

Furthermore, the method and the computer program according to the present invention, plural procedures are sequentially described, but the order in which the procedures are described is not limited to the order in which the plural procedures are performed. For this reason, when the method and the computer program according to the present invention are implemented, the order of the plural procedures can be changed within the scope that does not depart from the gist of the present invention.

Additionally, the order of the plural procedures in the method and the computer program according to the present invention is not limited to being individually performed at different timings. For this reason, another procedure may take place while a certain procedure is being performed, one or several portions or all portions of a timing at which a certain procedure is performed and one or several portions or all portions of a timing at which another procedure is performed may overlap, and so forth.

### Advantageous Effects of Invention

According to each of the aspects described above, a communication system, a communication apparatus, a method of controlling the communication apparatus and a program, in all of which a measurement value related to an amount of electric power can be collected in real time, can be provided.

### BRIEF DESCRIPTION OF THE DRAWINGS

The object described above, and other objects, features and advantages are further made apparent by suitable exemplary embodiments that will be described below and the following accompanying drawings.

FIG. 1 is a diagram illustrating an example of a configuration of a communication system that uses a communication apparatus according to an exemplary embodiment of the present invention.

FIG. 2 is a functional block diagram logically illustrating a configuration of the communication apparatus according to the exemplary embodiment of the present invention.

FIG. 3 is a block diagram illustrating a hardware configuration of the communication apparatus according to the exemplary embodiment of the present invention.

FIG. 4 is a flowchart illustrating an example of operation of the communication apparatus according to the present exemplary embodiment.

FIG. 5 is a functional block diagram logically illustrating a configuration of the communication apparatus according to the present exemplary embodiment.

FIG. 6 is a flowchart illustrating an example of the operation of the communication apparatus according to the present exemplary embodiment.

FIG. 7 is a functional block diagram logically illustrating the configuration of the communication apparatus according to the present exemplary embodiment.

FIG. 8 is a functional block diagram logically illustrating the configuration of the communication apparatus according to the exemplary embodiment of the present invention.

FIG. 9 is a diagram illustrating an example of the configuration of the communication system that uses the communication apparatus according to the exemplary embodiment of the present invention.

FIG. 10 is a block diagram illustrating the hardware configuration of the communication, apparatus according to the exemplary embodiment of the present invention.

FIG. 11 is a flowchart illustrating an example of the operation of the communication apparatus according to the present exemplary embodiment.

FIG. 12 is a functional block diagram logically illustrating a main configuration of the communication apparatus according to the exemplary embodiment of the present invention.

FIG. 13 is a diagram illustrating an example of the configuration of the communication system that uses the communication apparatus according to the exemplary embodiment of the present invention.

FIG. 14 is a flowchart illustrating an example of the operation of the communication apparatus according to the present exemplary embodiment.

FIG. 15 is a functional block diagram logically illustrating the main configuration of the communication apparatus according to the exemplary embodiment of the present invention.

FIGS. 16A and 16B are diagrams Illustrating an example of output of the communication state by an output unit of the communication apparatus according to the present exemplary embodiment.

FIG. 17 is a functional block diagram logically illustrating the main configuration of the communication apparatus according to the exemplary embodiment of the present invention.

FIG. 18 is a flowchart illustrating an example of the operation of the communication apparatus according to the present exemplary embodiment.

FIG. 19 is a functional block diagram logically illustrating a configuration of a server apparatus of the communication system according to the exemplary embodiment of the present invention.

FIG. 20 is a block diagram illustrating an example of a configuration of a computer that implements the server apparatus according to the exemplary embodiment of the present invention.

FIG. 21 is a functional block diagram logically illustrating a configuration of the server apparatus according to the present exemplary embodiment.

FIG. 22 is a functional block diagram logically illustrating the configuration of a server apparatus according to the present exemplary embodiment.

### DESCRIPTION OF EXEMPLARY EMBODIMENTS

Exemplary embodiments of the present invention will be described below with reference to the drawings. Moreover, in all the drawings, the same constituent elements are given the same reference numerals, and descriptions thereof are suitably omitted.

### First Exemplary Embodiment

A communication apparatus according to a first exemplary embodiment of the present invention, a method of controlling the communication apparatus, and a program will be described below.

To begin with, an entire configuration of a system that collects information which is acquired from an electric power meter using the communication apparatus according to the present exemplary embodiment will be described.

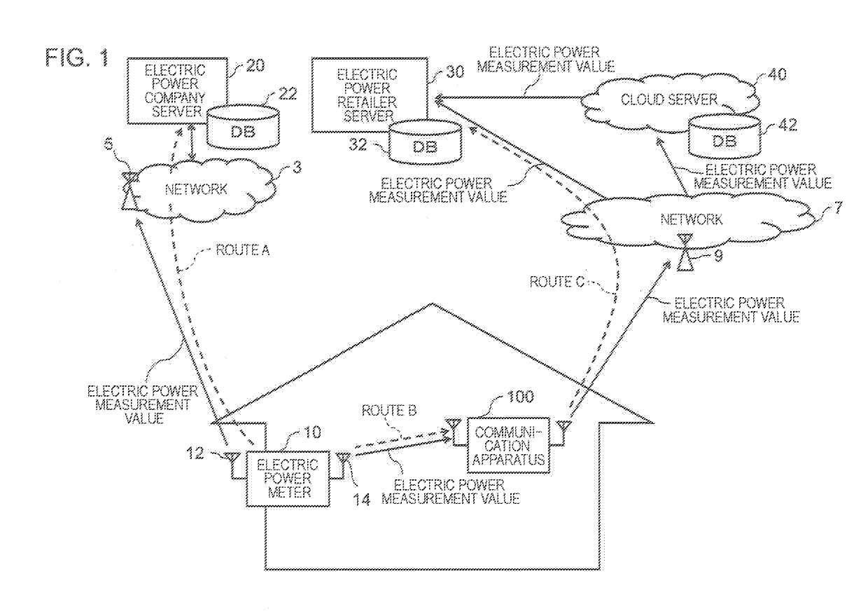

FIG. 1 is a diagram illustrating an example of a configuration of a communication system that uses a communication apparatus 100 according to the exemplary embodiment of the present invention.

In the communication system in FIG. 1, an electric power meter 10 is a smart meter or the like that has a communication unit and that measures an amount of consumption of electric power which is supplied from, an electric power company to a consumer, and, for example, is installed outside the consumer's home, at the entrance of the consumer's home, or at any other place. The electric power meter 10 periodically (for example, every 30 minutes) transmits meter reading data that is measured, such as an amount of consumption of electric power, to an electric power company server 20 through a first pathway (hereinafter also referred to as “Route A”), using the above-described communication unit.

As the electric power meter that is supplied by the electric power company to the consumer, there are a type that does not have the communication unit, and a type that has the communication unit as described above. According to the present invention, the electric power meter (the smart meter) that is the type which has the communication unit is used. The communication unit of this type of electric power meter performs communication through at least any one communication pathway of the first pathway (Route A) to the electric power company server 20 and a second pathway (hereinafter also referred to as Route B) to the communication apparatus inside the consumer's home. The communication unit of the electric power meter may be wired or wireless. Communication media and communication systems are not particularly limited as long as security is ensured.

The electric power meter 10 according to the present exemplary embodiment has a function of performing communication through two communication pathways. The electric power meter is configured to perform communication through the two communication pathways using two respective communication units, and has two antennas used by the two respective communication units. One of the antennas is a first antenna 12, and, for example, is used for connection to a network 3, such as a public network, through a base station 5, and additionally, for communication with the electric power company server 20 through the network 3. The first antenna 12, for example, is an antenna for communication in compliance with a specific low power wireless system that uses the 920 MHz band, or for communication with a mobile telephone communication network that uses a mobile telephone communication system, such as 3rd. Generation (3G) or Long Term Evolution (LTE). Furthermore, the electric power meter 10 may transmit information related to the amount of consumption of electric power to the electric power company server 20, in a wired manner, not in a wireless manner, in which case, the first antenna 12 is not necessary. The method of communicating with the electric power company server 20 is not particularly limited.

The other antenna is a second antenna 14 used for communication with the communication apparatus 100 inside the consumer's home through the second pathway (Route B) that is different from the first pathway (Route A). The second antenna 14, for example, is the antenna for communication in compliance with a specific low power wireless system that uses the 320 MHz band, but is not limited thereto.

Note that, for example, in a case where the electric power meter 10 transmits the meter reading data or the like to the electric power company server 20 through the first pathway (Route A) by performing multihop communication or the like using communication in compliance with the a specific low power wireless system, that uses the 920 MHz band, both of the first antenna 12 and the second antenna 14 are used for the communication in compliance with the specific low poser wireless system that uses the 920 MHz band. Thus, because two antennas, that is, the first antenna 12 and the second antenna 14 are not necessarily needed for the electric power meter 10, one antenna may be used for both the communication through the first pathway (Route A) and the communication through the second pathway (Route B). At this time, in the electric power meter 10, the usage time at which one communication antenna in the 920 MHz band is used is divided into the time for the communication through the first pathway (Route A) and the time for the communication through the second pathway (Route B).

By providing each consumer with the electric power meter 10, the electric power company can receive information related to the amount of consumption of electric power from each electric power meter 10 at a desired interval. However, in some cases, a business other than the electric power company, such as sin electric power retailer cannot receive the information related to the amount of consumption of electric power in real time. For example, the electric power company can receive the information related to the amount of consumption of electric power from the electric power meter 10 every 30 minutes through the first antenna 12, but the electric power retailer could only receive the same information at an interval of once or plural times a day.

In view of the above, the communication apparatus 100 according to the exemplary embodiment of the present invention has a function of periodically receiving (for example, every 30 minutes) the information related to the amount of consumption of electric power from the electric power meter 10 and transferring that information to an electric power retailer server 30 of the electric power retailer other than the electric power company.

Accordingly, instead of the normal reception of information related to the amount of electric power consumption once or plural times a day the electric power retailer server 30 can receive information related to the amount of consumption of electric power in real time, every 30 minutes, for example,

According to the present exemplary embodiment, the communication apparatus 100 may be a stationary (mounted) type or may be a mobile type. The installation location of the electric power meter 10 in the consumer's home may be limited due to availability of a good wireless communication environment with the electric power meter 10. Furthermore, there is a case where the environment of wireless communication with the electric power meter 10 changes with a change in the environment in the consumer's home or in the vicinity thereof. In such a case, if the communication apparatus 100 is implemented as a mobile-type small-sized terminal, the communication apparatus 100 can be moved, for use, to a place in the consumer's home, where the communication condition with the electric power meter 10 is favorable.

The communication apparatus 100 may be possessed by the consumer who is a user or may be rented to the user.

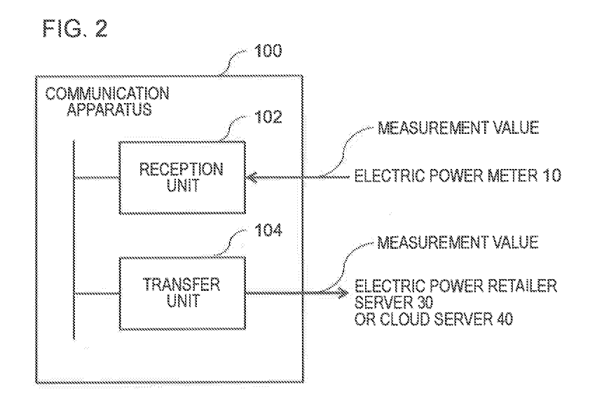

FIG. 2 is a functional block diagram logically illustrating a configuration of the communication apparatus 100 according to the exemplary embodiment of the present invention.

The communication apparatus 100 includes a reception unit 102 that receives a measurement value (for example, a 30-minute meter reading value) related to an amount of electric power, which is periodically transmitted through the first pathway (Route A) to a first destination (the electric power company server 20 in FIG. 1), through the second pathway (Route B) that is different from the first pathway, from the electric power meter 10, and a transfer unit 104 that transfers the received measurement value to a second, destination (the electric power retailer server 30, a cloud server 40, or the like in FIG. 1) that is different from the first, destination, through a third pathway (hereinafter also referred to as Route C) that is different from the first pathway and the second pathway.

According to the present invention, the first destination is a destination to which, the electric power meter 10 transmits a measurement value directly related to an amount of electric power. An example of the first destination is a server or the like of the electric power company chat has the authority to collect the measurement value directly related to the amount of electric power from the electric power meter 10, but the first destination may be a server that is assigned by the electric power company or the like to directly collect the measurement value related, to the amount, of electric power from the electric power meter 10, and is not particularly limited.

The second destination is a destination to which the communication apparatus according to the present invention transfers the measurement value related to the amount of electric power chat is collected from the electric power meter 10, and may be any destination that is different from at least the electric power meter 10. The reception unit 102 has at least a function of transferring the measurement value related to the amount of electric power that is collected from the electric power meter 10 to a destination that is different from the electric power meter 10. Additionally, the second destination is a destination that is an apparatus which cannot directly access the electric power meter 10 to collect the measurement value related to the amount of electric power, or the like, that is, a destination that is different from the first destination, and a server or the like of an electric power retailer other than the electric power company, or of a corporation that provides a service related to electric power is given an example of the second destination.

According to the present invention, the first pathway refers to a communication pathway between the electric power meter 10 and the first destination. The first pathway includes a pathway that is used when the measurement value directly related to the amount of electric power is transmitted from the electric power meter 10 to the first destination.

The second pathway is a pathway that is different from the first pathway, and refers to a communication pathway between, the electric: power meter 10 and the communication apparatus according to the present invention, which is inside the consumer's home. The second pathway includes a pathway that is used when the measurement value related to the amount of electric power is transmitted from the electric power meter 10 to the communication apparatus according to the present invention.

The third pathway is a pathway that is different from any one of the first pathway and the second pathway, and refers to a communication pathway between the communication apparatus according to the present invention and the second destination. The third pathway includes a pathway that is used when the measurement value related to the amount of electric power is transferred, from the communication apparatus according to the present invention to the second destination.

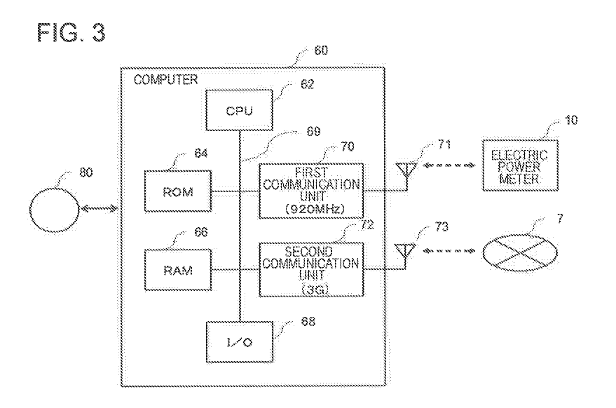

FIG. 3 is a block diagram illustrating a hardware configuration of the communication apparatus 100 according to the exemplary embodiment of the present invent ion.

Each constituent element of the communication apparatus 100 in FIG. 2 is implemented by an arbitrary combination of hardware and software of an arbitrary computer 60 that, as are illustrated in FIG. 3, includes a Central Processing Unit (CPU) 62, a memory (Random Access Memory (RAM)) 66, a program 80 that implements constituent elements in FIG. 2, which is loaded into the memory, a storage unit in which the program 80 is stored, such as a Read Only Memory (ROM) 64 or a flash memory, an Input/Output (I/O) 68, and an interface (a first communication unit 70 and a second communication unit 72) for network connection.

The ROM 64, the RAM 66, and the I/O 68 are connected to one another through a bus 69, and each element and the entire computer 60 are controlled by the CPU 62.

Note that each of the ROM 64 and the RAM 66 may be another memory or storage device that has a function for storing setting data for operating the program, temporarily-retained data, user data, and the like, such as a flash memory or a disk array,

Mote that, in FIG. 3, a configuration of a portion that is not related to the nature of the present invention is not illustrated, and for example, a display unit, an operation, unit, and the like are not illustrated.

Although not illustrated, the communication apparatus 100 may further have the display unit, such as a Light Emitting Diode (LED) or an organic Electro Luminescence (EL) diode, and the operation unit, such, as a switch, a dial, or an operation button.

Furthermore, the communication apparatus 100 may include a liquid display unit, a touch panel, or the like, but a simple configuration is desirable from the point of view of a manufacturing cost and a maintenance

Furthermore, the communication apparatus 100 according to the present exemplary embodiment may be in the form of a communication module that is able to be integrated into other apparatuses. Other apparatuses, for example, include a so-called Home Energy Management System (HEMS), a home electric power distribution board, and the like.

The first communication unit 70 performs communication in compliance with a specific low power wireless system that uses the 920 MHz band with the electric power meter 10 through a first antenna 71, for example, communication that is based on communication standard such as the WiSUN.

The second, communication unit 72 connects to a network 7 through the second antenna 73 in FIG. 1 by way of a base station 9 to communicate with the electric power retailer server 30 or the cloud server 40. The second communication unit 72 can perform communication by using, for example, a wireless communication system, such as Worldwide Interoperability for Microwave Access (WiMAX), 3G, or LTE.

Is this manner, the computer 60 that implements the communication apparatus 100 according to the present exemplary embodiment can perform communication through two different communication pathways using two communication systems. Note that, according to the present exemplary embodiment, as an example, the configuration is described in which the communication apparatus 100 (the computer 60) includes two communication units, that is, the first communication unit 70 and the second communication unit 72, to perform communication through two different communication pathways using different communication systems. However, the communication apparatus 100 (the computer 60) may perform communication through two different communication pathways using the same communication system. In that case, for example, the two different communication pathways may use different channels. Furthermore, if timings for communication through the two different communication pathways can be controlled so that they are not performed at the same time, a configuration may be employed in which one communication unit performs communication through two different communication pathways.

By reading out the program 80 stored in the storage unit (ROM 64) to the memory (RAM 66) and executing the program 80, the CPU 62 of the computer 60 in FIG. 3 can implement a function of each of the units of the communication apparatus 100 in FIG. 2.

A computer program 80 according to the present exemplary embodiment is written in such a manner that the computer 60 which implements the communication apparatus 100 is caused to execute: a procedure of receiving a measurement value (30-minute value; related to the amount of electric power, which is periodically transmitted to the first destination (electric power company server 20 or the like) through the first pathway (Route A), from the electric power meter 10 through the second pathway (Route B) that is different from the first pathway; and a procedure of transferring the received measurement value to the second destination (electric power retailer server 30, cloud server 40, or the like) that is different from, the first destination, through, the third pathway (Route C) that is different from the second pathway.

Note that the second, destination in the procedure of transferring may be any destination so long as it is different from at least the electric power meter 10. The computer program 8 0 according to the present invention may be written in such a manner that the computer 60 is caused to execute a procedure of transferring the measurement value that is received from the electric power meter 10 to a destination that is different from the electric power meter 10.

The computer program 80 according to the present exemplary embodiment may be recorded on a recording medium that is readable by the computer 60. There is no limitation to the recording medium, and recording media in the various forms are considered. Furthermore, the program 80 may be loaded from the recording medium into the memory of the computer 60, and may be downloaded to the computer 60 through a network and may be loaded into the memory.

The recording media on which to record the computer program 80 include a non-transitory medium that is usable by a computer, and program codes that are readable by a computer is embedded into the medium. When executed on the computer 60, the computer program 80 causes the computer 60 to perform a method of controlling the communication apparatus 100 that implements the communication apparatus 100, which will be described below.

Returning to FIG. 2, the reception unit 102 uses the first communication unit 70 and the first antenna 71 in FIG. 3 to receive the measurement value (30-minute meter reading data) related to the amount of electric power from the electric power meter 10. In the communication with the electric power meter 10, it is assumed that predetermined authentication processing has already been completed, in such a manner that information can be acquired from the electric power meter 10. An authentication processing method will be described, below. Furthermore, at the time of the communication, it is preferable that predetermined encryption processing or the like is performed to ensure security.

The expression “acquiring” in the present specification includes at least any one of: the own apparatus fetching (actively acquiring) data or information stored in another apparatus or in a storing medium, for example, such as receiving data or information by making a request to or making an inquiry to another apparatus, or accessing another apparatus or the storing medium, and reading out data, or information; and inputting (passive acquiring) data or information that is output, from another apparatus into the own apparatus, for example, such as receiving data or information that is delivered, (transmitted, push-notified, or the like). Furthermore, “acquiring” includes selecting and acquiring from among pieces of received data or information, and selecting and receiving delivered data or information.

The measurement values related to the amount of electric power are periodically transmitted, from the electric power meter 10 to the electric power company server 20 that is the first destination, through Route A. In the present exemplary embodiment, the values are concurrently transmitted from the electric power meter 10 to the communication apparatus 100.

Note that, according to the present invention, the measurement value related to the amount of electric power that is received from the electric power meter 10, for example, is information that includes at least any one of an electric-power instantaneous-value that is measured by the electric power meter 10 and an electric-power integrated-value for a predetermined period of time, and point-in-time information on each value. Additionally, energy consumption information may include a reverse power flow value of surplus power of a generator or the like, and point-in-time information thereon. The predetermined period of time, for example, is 30 minutes, but is not limited thereto.

Furthermore, according to the present, invention, there are various reception methods from the electric power meter 10 as will be described below, but is not limited thereto:

(a1) Receiving a measurement value automatically outputted every 30 minutes from the electric power meter 10 after authentication processing.

(a2) Periodically receiving information by the communication apparatus 100 making at least one request to the electric power meter 10 for output of information, after authentication processing. Note that the request may be made whenever reception of information is needed.

The transfer unit 104 connects to the network 7 using the second communication unit 72 and the second antenna 73 in FIG. 3, and transfers the measurement value, which is received by the reception unit 102, to the electric power retailer server 30 or the cloud server 40 that is the second destination, through the third pathway (Route C). It is assumed that, predetermined, authentication processing has been completed in the connection to the network 7 and in the communication with the electric power retailer server 30 or the cloud server 40. The authentication processing method will be described below. Furthermore, at the time of communication, it is preferable that a predetermined encryption processing or the like is performed to ensure security.

Note that, when the reception unit 102 receives the measurement value from the electric power meter 10, the transfer unit 104 may transfer the measurement value. Specifically, the transferring timing of the measurement value by the transfer unit 104 may be immediately after reception of the value from the electric power meter 10, after reception of data covering a predetermined time, and at a predetermined time, periodically, or when requested from the electric power retailer server 30 or the cloud server 40. The transfer timing may be determined based, on at least any one of a storage capacity of the communication apparatus 100, a processing load of the communication apparatus 100, a communication state of the third pathway, a processing load, of the electric power retailer server 30 or the cloud server 40, and the like, and may be appropriately changed, automatically or manually. The communication apparatus 100 may have a configuration allowing the timing to be set. More precisely, the transfer timing by the transfer unit 104 immediately after reception of the measurement value by the reception unit maybe at an interval of 30 minutes, or at other timings.

In the present exemplary embodiment, the transfer unit 104 transfers the measurement value immediately after the reception unit 102 receives the measurement value.

The method of controlling the communication apparatus 100 according to the present exemplary embodiment configured in the above manner will be described below.

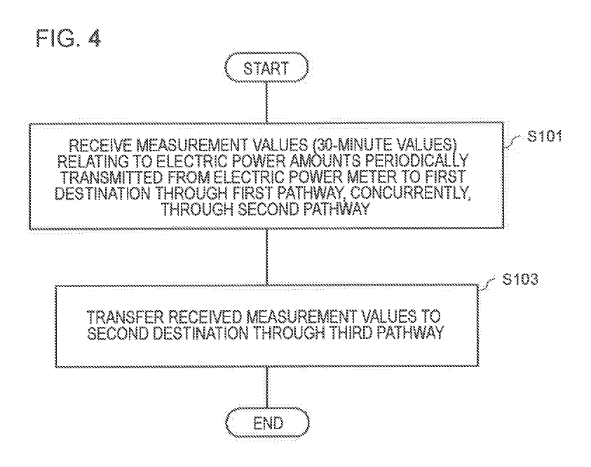

FIG. 4 is a flowchart illustrating an example of operation of the communication apparatus 100 according to the present exemplary embodiment.

The control method, according to the exemplary embodiment of the present invention is a method of controlling the communication apparatus 100, and is a control method, that is performed by the computer 60 which implements the communication apparatus 100.

The control method according to the present exemplary embodiment includes the communication apparatus 100 receiving the measurement value (30-minute value) relating to the amount of electric power, which is periodically transmitted to the first, destination (the electric power company server 20 or the like) through the first pathway (Route A), concurrently, from the electric power meter 10 through the second pathway (Route B) that is different from the first pathway (Step S101), and transferring the received measurement value to the second destination (the electric power retailer server 30, the cloud server 40, or the like) that is different from the first destination, through the third pathway (Route C) that is different from the second pathway (Step S103).

Note that the second destination in Step S103 may be different from at least the electric power meter 10. The method of controlling the communication apparatus 100 according to the present invention includes transferring, by the communication apparatus 100, the measurement value that is received from the electric power meter 10, to a destination that is different from the electric power meter 10.

As described above, in the communication apparatus 100 according to the exemplary embodiment of the present invention, first, the reception unit 102 receives the measurement values (30-minute values) related to the amounts of electric power, which are periodically transmitted to the first destination (the electric power company server 20 or the like) through the first pathway (Route A), concurrently, from the electric power meter 10 through the second, pathway (Route B) that is different from the first pathway. Then, the transfer unit 104 transfers the received measurement values to the second destination (the electric power retailer server 30, the cloud server 40, or the like) that is different from the first destination, through the third pathway (Route C) that is different from the first pathway and the second pathway.

Accordingly, the communication apparatus 100 according to the present exemplary embodiment is capable of receiving the information that is the measurement values related to the electric power which are periodically transmitted from the electric power meter 10 to the electric power company server 20 concurrently from the electric power meter 10, and additionally, transferring the received information to the electric power retailer server 30 or the cloud server 40. Therefore, it is possible for the electric power retailer server 30 or the cloud server 40 to acquire information immediately, whenever the electric power meter performs output, whereas the information has not been conventionally receivable in real time due to the reception frequency which had been set to one or plural times a day. That is, it is possible to collect information in real time.

### Second Exemplary Embodiment

Next, a communication apparatus according to a second exemplary embodiment of the present invention, and a method of controlling the communication apparatus will be described, below.

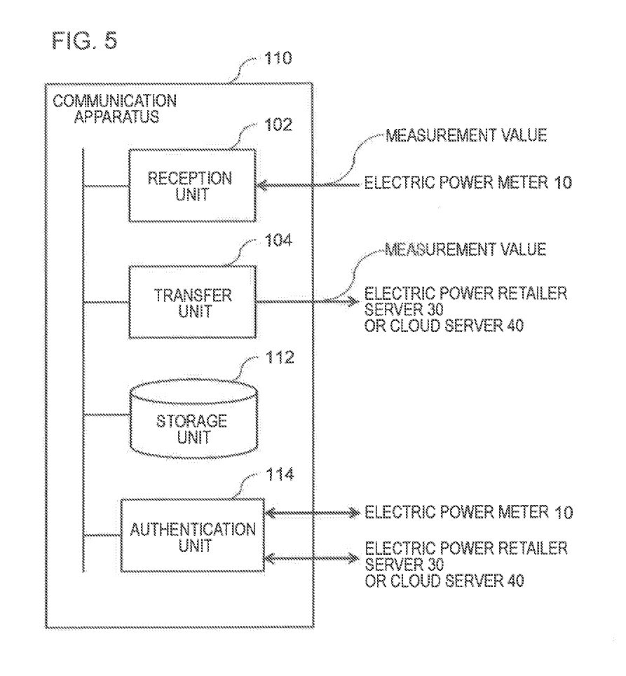

FIG. 5 s a functional block diagram, logically illustrating a configuration of a communication apparatus 110 according to the present exemplary embodiment.

The communication apparatus 110 according to the present exemplary embodiment is different from the communication apparatus 100 according to the exemplary embodiment, which is described above with reference to FIG. 2, in that the communication apparatus 110 has a configuration in which authentication processing for communication is automatically performed, allowing communication to be immediately started.

The communication apparatus 110 according to the present exemplary embodiment has the reception unit 102 and the transfer unit 104 that are the same as those of the communication apparatus 100 in FIG. 2, and further has a storage unit 112 and an authentication unit 114.

In the communication apparatus 110, information for authenticating each of the electric power meter 10 and the second destination, (the electric power retailer server 30 or the cloud server 40) is stored in advance in the storage unit 112. The authentication unit 114 makes an authentication connection to the electric power meter based on the authentication information.

Using the authentication information, the authentication unit 114 authenticates each of the electric power meter 10 and the second destination (the electric power retailer server 30 or the cloud server 40).

The storage unit 112 may be included, within the communication apparatus 110 as illustrated in the drawing, may be a recording medium that is detachably attached to the communication apparatus 110, or may be connected to the outside of the communication apparatus 110 in a wired or wireless manner to allow the communication apparatus 110 to access the storage unit 112.

The storage unit 112, for example, is the ROM 64 or RAM 66 in FIG. 3. The information for authenticating each of the electric power meter 10 and the second destination (the electric power retailer server 30 or the cloud server 40) may he included in advance in the program 80, and the authentication information included in the program 80 may be written to the ROM 64 and loaded from the ROM 64 into the RAM 66 for storage.

The authentication information stored in the storage unit 112 may be information for authenticating each of the electric power meter 10 and the second destination, and a specific detail thereof may be determined depending on the authentication technique. In the present exemplary embodiment, the technique for authenticating between the communication apparatus and the electric power meter 10, and between the communication apparatus and the second destination is not limited.

For communication with the electric power meter 10, the authentication identification information, for example, includes identification information that is given in advance to the electric power meter 10, a password that is linked to the identification information, and the like.

Furthermore, for communication with the second destination, the authentication information, for example, includes a user ID for logging in to the electric power retailer server 30 or the cloud server 40, which is determined in advance, and a password that is linked to the user ID. Additionally, the authentication information includes identification information, a password that is linked to the identification information, an encryption key, and the like, for making a connection to the network 7.

Authentication information for communication with the electric power meter 10 and that for communication with the second destination are stored in advance in the storage unit 112.

The authentication unit 114 authenticates each of the electric power meter 10 and the second destination, using each piece of authentication information. After the authentication succeeds, it is possible for the reception unit 102 and the transfer unit 104 to communicate with the electric power meter 10 and the second destination, respectively.

In the present exemplary embodiment, an example of the authentication information being stored in advance in the storage unit 112 to be used for authentication processing has been explained.

In another example, the communication apparatus 110 may include an authentication information acquisition unit (not illustrated) that acquires the information for authenticating the electric power meter 10 based on identification information on the own communication apparatus 110.

The storage unit 112 stores the information for authenticating the electric power meter 10 acquired by the authentication information acquisition unit.

The reception unit 102 receives the measurement values periodically transmitted from the electric power meter 10 authenticated and connected by the authentication unit 114 to the first destination through the first pathway, through the second pathway that is different from the first pathway.

The transfer unit 104 transfers the received, measurement values to the second destination that is different from the first destination, through the third pathway that is different from the first pathway and the second pathway.

An acquisition unit 116 acquires the information for authenticating the electric power meter 10 from the second destination (the electric power retailer server 30 or the cloud server 40) through the third pathway. The information for authenticating the electric power meter 10, which is acquired by the acquisition unit 116, is stored in the storage unit 112. The authentication unit 114 performs authentication connection of the electric power meter 10 using the authentication information that is stored in the storage unit 112,

Furthermore, information for authenticating the electric power meter 10 may be acquired when using the communication apparatus 110 according to the present exemplary embodiment for the first time and stored in the storage unit 112, to automatically and autonomously perform authentication processing.

For example, when the own apparatus is powered on, the acquisition unit 116 acquires the information for authenticating the electric power meter 10 based on identification information of the own apparatus, and the authentication unit 114 authenticates and connects the electric power meter 10 based on the acquired authentication information.

An example of an authentication, processing method that is performed when the communication apparatus 110 is used for the first time or when the communication apparatus 110 communicates with a different electric power meter 10 than before will be described below. In this example, the information for authenticating the electric power meter 10 is acquired from the second destination (the electric power retailer server 30 or the cloud server 40) through the third pathway.

First, each consumer (user) notifies, in advance, the second destination (the cloud server 40) that communicates with the communication apparatus 110 of identification information ID and a password PW for the electric power meter 10 in the consumer's home, using a personal computer or a mobile telephone. Specifically, when the user purchases the communication apparatus 110 or becomes a user of the communication apparatus 110, the user is provided with identification information of the communication apparatus 110, Uniform Resource Locator (URL) information of a website for performing user registration of the communication apparatus 110, and the like. The above information may be described in an operation manual of the communication apparatus 110 or a document supplied with the communication apparatus 110. The information itself may be described or may be in the form of a symbol such as a Quick Response (QR) (a registered trademark) code.

The user connects to the website for user registration using the user's personal computer or mobile telephone. It is assumed that the connection and communication to the website is performed in an encrypted and secure state.

On the website, according to the guidance, the user inputs the authentication information such as the identification information of the communication apparatus 110, and the identification information ID and the password PW for the electric power meter 10, into an input form. The authentication information, for example, may be described in operation manuals of the communication apparatus 110 and the electric power meter 10 or an enclosed form. The user inputs the described authentication information into the input form. In this manner, the identification information of the communication apparatus 110, and the identification information ID and the password PW for the electric power meter 10 are transmitted to the cloud server 40.

Then, the cloud server 40 stores the identification information ID of the communication apparatus 110 and the identification information ID and the password PW for the electric power meter 10, which are received, in a database 42 in a state of being linked to each other.

On the other hand, when the user powers on the communication apparatus 110 for the first time, the communication apparatus 110 accesses the storage unit 112, and automatically makes an attempt to make a connection to the cloud server 40 using the authentication information for performing communication with the second destination (for example, the cloud server 40) described above.

Then, if the authenticated, connection to the cloud server 40 through the network 7 are established, the identification information ID and the password W for the electric power meter 10, which are linked to the communication apparatus 110, are transmitted from, the cloud server 40 to the communication apparatus 110 through the network 7. Then, the communication apparatus 110 stores the received authentication information in the storage unit 112. Then, the communication apparatus 110 automatically and autonomously attempts connection and authentication for communication with the electric power meter 10 through the second pathway (Route B), using the received information for authenticating the electric power meter 10.

More precisely, the communication apparatus 110 performs communication with the cloud server 40 as the second destination using authentication information stored, in the storage unit 112, and performs communication with the electric power meter 10 using authentication information acquired from, the cloud server 40.

With this procedure, the user can perform communication with the electric power meter 10 and connection and authentication processing for communicating with the second destination (for example, the cloud server 40) are automatically and autonomously performed just by powering on the communication apparatus 110.

The program for the communication apparatus 110 according to the present exemplary embodiment may cause at least one computer (for example, the computer 60 in FIG. 3) to perform the method of controlling the communication apparatus 110, or may be a computer-readable recording medium on which the program is recorded. The recording media include a non-transitory physical medium.

The computer program includes computer program codes that, when executed, by the computer, causes the computer to perform the method of controlling a communication apparatus, on the communication apparatus.

The method of controlling the communication apparatus 110 according to the present, exemplary embodiment, which is configured in this manner, will be described below.

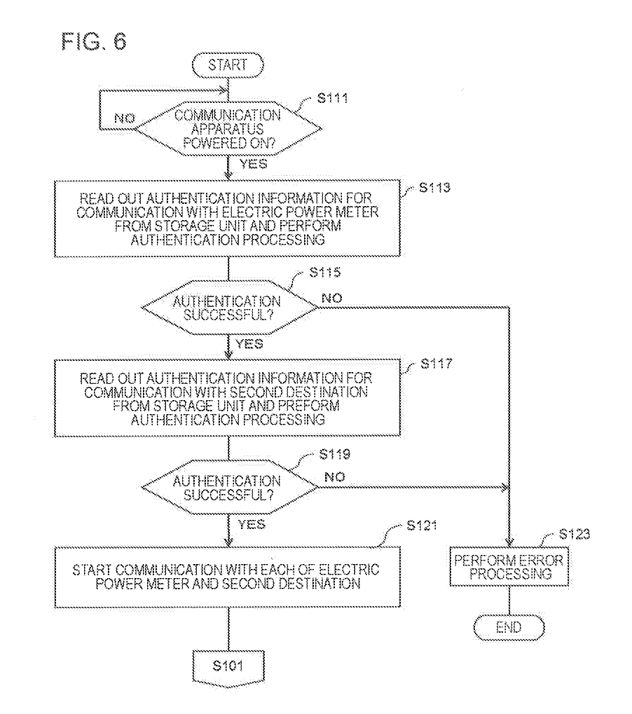

FIG. 6 is a flowchart illustrating an example of operation of the communication apparatus 110 according to the present exemplary embodiment.

First, for example, when the communication apparatus 110 is installed inside the consumer's home and is powered on (YES in Step S111), the authentication unit 114 acquires the authentication information for communication with the electric power meter 10 and performs authentication processing (Step S113). The information for authenticating the electric power meter 10 may be acquired from, the second destination (the electric power retailer server 30 or the cloud server 40) through, the third pathway, or may be acquired by reading out the authentication information in the storage unit 112, which is acquired and stored in advance.

Then, when authentication succeeds (YES in Step S115), additionally, the authentication unit 114 reads out the authentication information for communication with the second destination from the storage unit 112, and performs authentication processing (Step S117). Then, when authentication succeeds (YES in Step S113), communication with the electric power meter 10 and communication with the second destination are started at respective timings (Step S121). Thereafter, the step proceeds to Step S101 in the flowchart in FIG. 4, and the reception unit 102 receives a measurement value related to electric power from the electric power meter 10.

On the other hand, in Step S115 or Step S119, in a case where authentication fails (NO in Step S115 or NO in Step S119), error processing is performed (Step S123) and the processing is ended.

The error processing, for example, includes processing that provides information for notifying the user of a failed communication connection, on the display unit of the communication apparatus 110. Furthermore, the authentication processing may be repeated up to a predetermined number of times. A method of notifying the user, for example, includes displaying the detail of the notification using color, a flashing pattern, an expression in alphanumeric characters, or the like determined, in advance.

Note that processing for authenticating the electric power meter 10 in Step S113 and Step S115 and processing for authenticating the second destination in Step S117 and Step S119 in FIG. 6 are reversed in processing order in the above example in which authentication information is acquired later. That is, the processing for authenticating the second destination is first performed and the processing for authenticating the electric power meter 10 is then performed.

With this configuration, the information for authenticating each of the electric power meter 10 and the second destination (the electric power retailer server 30 or the cloud server 40) is stored in advance in the storage unit 112, and the authentication unit 114 authenticates each of the electric power meter 10 and the second destination by using the authentication information, thus allowing communication to be performed.

Alternatively, the acquisition, unit 116 of the communication apparatus 110 acquires information (ID and PW) for authenticating the electric power meter 10 from the cloud server 40 or the like based on identification information of the own apparatus, authentication and connection to the electric power meter 10 is performed based, on the authentication information acquired by the authentication unit 114 thus allowing communication to be performed.

Accordingly, because starting to use the communication, apparatus 110 is simple by just installing the communication apparatus 110 inside the consumer's home and powering on the communication apparatus 110, there is no need for a service technician or the like to make a visit for an initial setting. The installation cost can be reduced and ease of use may also be achieved. Additionally; by performing the authentication processing, communication security is improved.

### Third Exemplary Embodiment

Next, a communication apparatus according to a third exemplary embodiment of the present invention, and a method of controlling the communication apparatus will be described below.

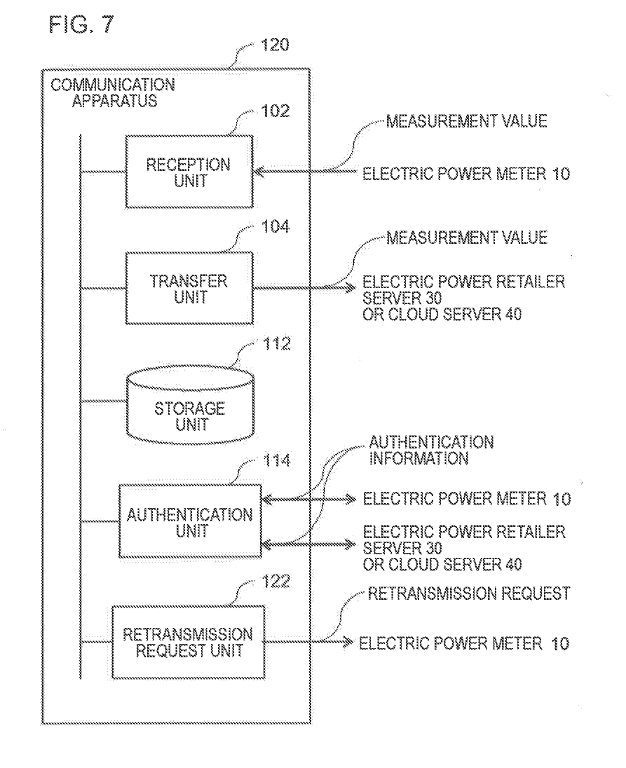

FIG. 7 is a functional block diagram logically illustrating a configuration of a communication apparatus 120 according to the present exemplary embodiment.

The communication apparatus 120 according to the present exemplary embodiment is different from that according to the exemplary embodiment described with reference to FIG. 2 and FIG. 5, in that the communication apparatus 120 is further configured to make a retransmission request when there is a lack of the measurement value that is received from the electric power meter 10.

The communication apparatus 120 according to the present exemplary embodiment has the reception unit 102, the transfer unit 104, the storage unit 112, and the authentication unit 114 that are the same as those of the communication apparatus 110 in FIG. 5, and further has a retransmission request unit 122,

Note that the communication apparatus 120 in FIG. 7 illustrates an example of a combination of a configuration of the communication apparatus 110 in FIG. 5 added with the retransmission request unit 122, but the retransmission request unit 122 may be combined with at least any one of the configuration of the communication apparatus 100 in FIG. 2 and a configuration of a communication apparatus according to other exemplary embodiments, which will be described below.

In the communication apparatus 120 according to the present exemplary embodiment, the retransmission request unit 122 temporarily retains the measurement value that is received from the electric power meter 10, in the RAM 66, or the like. Furthermore, when the determination is made that there is a lack based, on a result of determination of whether or not there is the lack of the measurement value, the retransmission request unit 122 requests the electric power meter 10 to retransmit a part of the lack of the measurement value.

For example, the retransmission request unit 122 temporarily retains the measurement value, which is received by the reception unit 102 every 30 minutes, in the RAM 66. As described above, the measurement value, which is transmitted from the electric power meter 10, includes point-in-time information of the measurement value. Based on pieces of point-in-time information on plural measurement values that are retained, the retransmission request unit 122 determines whether or not there is a lack of the measurement values. A case where it is determined that there is a lack of the measurement value will be described below. In a case where there is a correspondence to at least any one of the following cases, it is determined that there is a lack of the measurement value:

(b1) A time interval between the measurement values is longer than a data collection interval (for example, 30 minutes) due to a communication error with the electric power meter 10.

(b2) A format or data format of information that is received from the electric power meter 10 is in correct or data is missing.

(b3) At least any one of the measurement value and the point-in-time information is not included in the information that is received from the electric power meter 10.

(b4) The measurement value that is received from the electric power meter 10 is abruptly increased or decreased by a predetermined value or above in the history of the measurement values in a predetermined period of time.

The measurement value that is retransmitted from the electric power meter 10 in response to the retransmission request is received by the reception unit 102.

Note that, according to the present exemplary embodiment, after it is determined by the retransmission request unit 122 that there is not a lack of the measurement value, the transfer unit 104 may sequentially or collectively transfer plural measurement values that are temporarily retained, to the second destination. Alternatively, regardless of the initial reception or the reception after the retransmission request, the transfer unit 104 may transfer a measurement value to the second destination whenever the reception unit 102 receives a measurement value.

The program for the communication apparatus 120 according to the present exemplary embodiment may be a program that causes at least one computer (for example, the computer 60 in FIG. 3) to perform the method of controlling the communication apparatus 120, or may be a computer-readable recording medium on which the program is recorded. The recording media include a non-transitory physical medium.

The computer program includes computer program codes that, when executed by the computer, causes the computer to perform the method of controlling a communication apparatus, on the communication apparatus.

The method of controlling the communication apparatus 120 according to the present exemplary embodiment, which is configured in this manner, will be described below.

The method of controlling the communication apparatus 120 according to the present exemplary embodiment includes causing the communication apparatus 120 to temporarily retain the measurement value that is received from the electric power meter 10, in the RAM 66, or the like, and causing the communication apparatus 120 to requests the electric power meter 10 to retransmit there is a part of the lack of the measurement value, in a case where, based on a result of determining whether or not there is a lack of the measurement value, it is determined that there is a lack of the measurement value.

With this configuration, in the communication apparatus 120, the retransmission request unit 122 is able to temporarily retain the measurement value that i s received from the electric power meter 10, and, based on the result of determining whether or not there is a lack of the measurement value, make a retransmission request to the electric power meter 10. Accordingly, leakage in the measurement values transferred to the second destination can be reduced and reliability can be improved.

### Fourth Exemplary Embodiment

Next, a communication apparatus according to a fourth, exemplary embodiment of the present invention, and a method of controlling the communication apparatus will be described below. Note that, a program according to the present exemplary embodiment causes at least one computer to perform the method of controlling the communication apparatus in the same manner as in the exemplary embodiments described above, and that a detailed description thereof is omitted in the present exemplary embodiment.

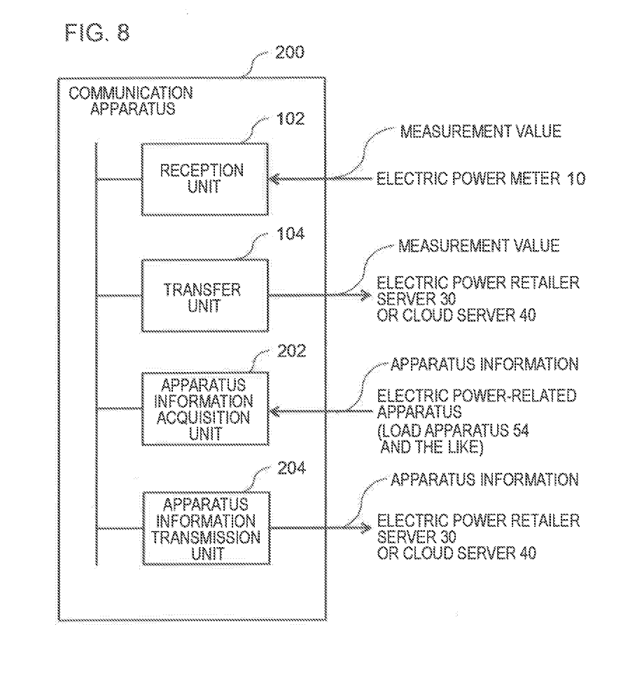

FIG. 8 is a functional block diagram logically illustrating a configuration of a communication apparatus 200 according to the exemplary embodiment of the present invention.

The communication apparatus 200 according to the present exemplary embodiment is different from those according to the embodiments described above with reference to FIG. 2, FIG. 5 and FIG. 7, in that the communication apparatus 200 acquires apparatus information from another electric power-related apparatus and has a configuration that the apparatus information, in addition to the measurement value, is transferred to the second destination.

Note that the communication apparatus 2 00 according to the present exemplary embodiment is described as an example that results from a combination with the configuration of the communication apparatus 100 in FIG. 2, but may result from a combination with a configuration of at least one of the communication apparatuses according to other exemplary embodiments, which are described above and will be described below,

The communication, apparatus 200 according to the present exemplary embodiment has the same configuration as the communication apparatus 100 according to the exemplary embodiment, which is described above, and further includes an apparatus information acquisition unit 202 and an apparatus information transmission unit 204.

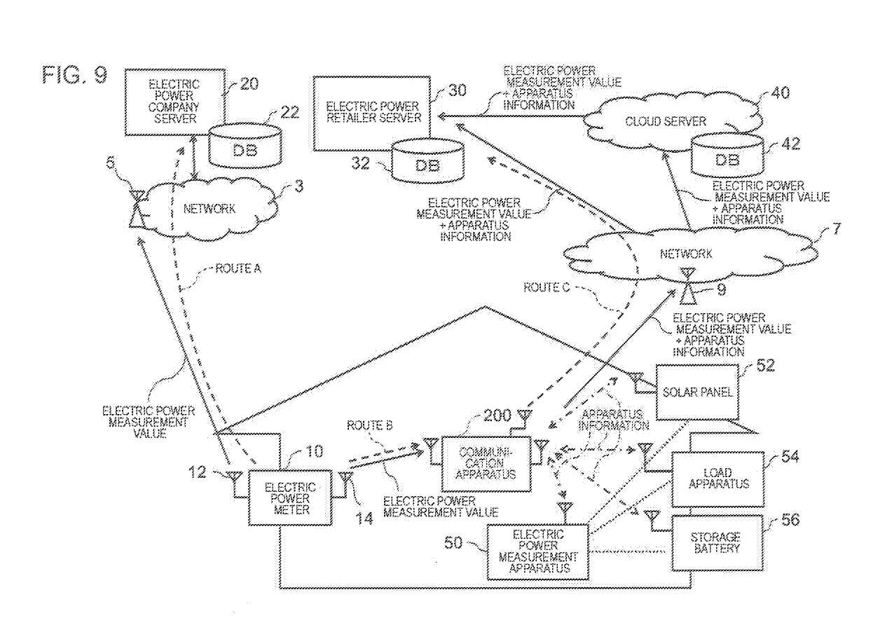

Furthermore, FIG. 9 is a diagram illustrating an example of a configuration of a communication system, chat uses the communication apparatus 200 according to the exemplary embodiment of the present invention.

The configuration of the communication apparatus 200 will be described with reference to FIG. 8 and FIG. 9.

In the communication apparatus 200 according to the present exemplary embodiment, the apparatus information acquisition unit 202 acquires apparatus information on each electric power-related apparatus from plural electric power-related apparatuses.

The apparatus information includes at least any one of information related to a driving state, information related to electric power consumption, information related to electric power generation, and information related to electric power storage, from electric power-related apparatuses (including an electric power measurement apparatus 50 in FIG. 9) that include at least any one of a load apparatus 54, an electric power generator (a solar panel 52 in FIG. 9), and an electricity storage apparatus (a storage battery 56 in FIG. 9).

The apparatus information transmission unit 204 transmits, in addition to the measurement value, the apparatus information, which is acquired by the apparatus information acquisition unit 202, to the second destination, through the third pathway.

At this point, the electric power-related apparatuses, as illustrated in FIG. 9 include the electric power measurement apparatus 50, the solar panel 52, the load apparatus 54, and the storage battery 56. A configuration in FIG. 9 is one example, and the type of apparatus or the number of apparatuses are not limited thereto. The electric power measurement apparatus 50 is connected to the electric power-related apparatus, such, as the solar panel 52, the load apparatus 54, and the storage battery 56, and for example, measures electric current of each apparatus using a current transformer (CT). Additionally, the electric power measurement apparatus 50 has a function of wirelessly transmitting information related to a measured electric power usage amount by each apparatus to the communication apparatus 200.

The load apparatus 54 is an electrical home appliance or the like that consumes electric power. As one example, the load apparatuses 54 include various apparatuses, such as a refrigerator 54a, an air conditioner 54b, and a lighting system 54c. Electric power that is generated in the solar panel 52 is stored in the storage battery 56, and is used whenever necessary, or surplus electric power is sold to an electric power company. The electric power measurement apparatus 50 can further measure an amount of electric power that is generated in the solar panel 52, an amount of electric power that is stored in or discharged from the storage battery 56, an amount of electric power that is sold to the electric power company, and the like. These amounts of electric power can be transmitted to the communication apparatus 200. Furthermore, the electric power-related apparatus is not limited to those illustrated here. For example, Home Energy Management System (HEMS), home electric power distribution board, and the like are included. Furthermore, the electric power measurement apparatus 50 and the communication apparatus 200 may be integrated into one apparatus or may be separate apparatuses. An integrated apparatus means that one predetermined apparatus has functions of the electric power measurement apparatus and the communication apparatus. In a case where the communication apparatus 200 and the electric power measurement apparatus 50 are integrated into one apparatus, the communication apparatus 200 collects the apparatus information directly from each electric power-related apparatus.

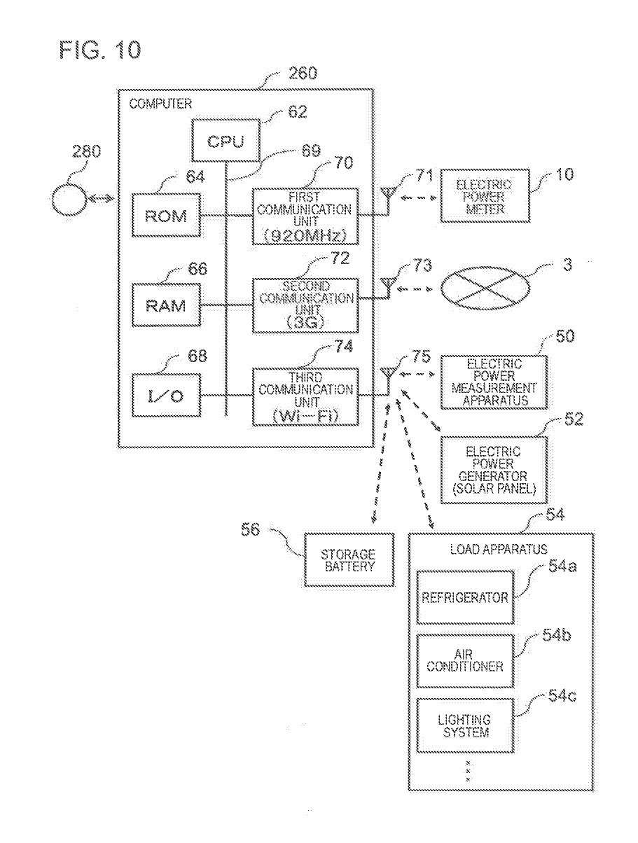

FIG. 10 is a block diagram illustrating a hardware configuration of the communication apparatus 200 according to the exemplary embodiment of the present invention.

Each constituent element of the communication apparatus 200 in FIG. 8 is implemented by an arbitrary combination of hardware and software of the computer 260 that is illustrated in FIG. 10. The computer 260 in FIG. 10 has the configuration of the computer 60 in FIG. 3 that implements the communication apparatus in FIG. 2. FIG. 5, or FIG. 7, and further includes a third communication unit 74.

The third, communication unit 74 communication in a wireless manner with the electric power-related apparatuses, such as the electric power measurement apparatus 50, the solar panel 52, the load apparatus 54, and the storage battery 56 in FIG. 9, through a third antenna 75. The third, communication unit 74 is not particularly limited, as long as it communicates with each apparatus. For example, the third communication unit 74 performs wireless Local. Area Network (LAN) communication (for example, Wi-Fi), or communication in compliance with a specific low power wireless system that uses the 920 MHz band. For example, the third communication unit 74 may use an ECHONET Lite communication protocol to communicate with each apparatus. Furthermore, in the drawing, the third communication unit 74 is illustrated as one unit having one antenna, but may include plural communication units that each performs communication through each of plural antennas in compliance with each of plural communication systems different from each other.

In the present specification, a pathway that is used when the third communication unit 74 communicates with the electric power-related apparatus is referred to as a fourth pathway, and the fourth pathway is different from any one of the first pathway, the second pathway, and the third pathway.

In this manner, the computer 260 that implements the communication apparatus 200 according to the present exemplary embodiment can perform communication through three different communication pathways using three communication systems. Note that, according to the present exemplary embodiment, as an example, the configuration is described in which the communication apparatus 200 (the computer 260) includes three communication units, that is, the first communication unit 70, the second communication unit 72, and the third communication unit 74, and performs communication through three different communication pathways using different communication systems, but is not limited thereto.

For example, one of the first communication unit 70 and the second communication unit 72 may be equipped with a function of communicating in a wireless manner with the electric power-related apparatus that has the third communication unit 74. In that case, the communication apparatus 200 does not need to include the third communication unit 74.

Furthermore, the communication apparatus 200 (the computer 260) may perform communication through three different communication pathways using at least one same communication system. In that case, for example, the three communication pathways may use different channels. Furthermore, in a case where control can be performed in such a manner that timings for communication through the three different communication pathways are not the same, a configuration may be employed in which the communication through the three different communication pathways is performed with one communication unit.

By reading out and executing the program 280 that is stored in the memory (RAM 66), the CPU 62 of the computer 260 in FIG. 10 can implement a function of each of the units of the communication apparatus 200 in FIG. 8.

Returning to FIG. 8, the apparatus information acquisition unit 202 connects to the electric power-related apparatus using the third communication unit 74 and the third antenna 75 in FIG. 10 and acquires apparatus information that includes at least one of information related to a driving state, information related to electric power consumption, information related to electric power generation, and information related to electric power storage, from each, apparatus through the fourth pathway. In the communication with each apparatus, it is assumed that predetermined authentication processing has already been completed in such a manner that the apparatus information can be acquired f roe each apparatus. Here, it is assumed that communication with each electric power-related apparatus is performed through a HEMS that is not illustrated, and that authentication processing is performed between the HEMS and the communication apparatus 200 after the communication between the HEMS and each apparatus is established. The authentication processing method will be described, below. Furthermore, during communication, a predetermined encryption processing or the like is preferably performed to ensure security.

Note that, as an example, a configuration is described here in which the communication apparatus 200 is connected to each electric power-related apparatus through the HEMS, but the communication apparatus 200 may be configured to be connected to the electric power-related apparatus without involving the HEMS. Furthermore, a combination of a configuration in which some electric power-related apparatuses are connected to the communication apparatus 200 through the KEMS and a configuration in which other electric power-related apparatuses are connected to the communication apparatus 200 without using she HEMS may be employed.

The apparatus information transmission unit 204 connects to the network 7 using the second communication unit 72 and the second antenna 73 in FIG. 10, and transmits the apparatus information, which is acquired by the apparatus information acquisition unit 202, to the electric power retailer server 30 or the cloud server 40 that is the second destination, through the third pathway (Route C). It is assumed that, the predetermined authentication processing has already been completed in the connection to the network 7 and in the communication with the electric power retailer server 30 or the cloud, server 40. The authentication processing method will be described below. Furthermore, at the time of communication, a predetermined encryption processing or the like is preferably performed to ensure security.

An acquisition timing and a transmission timing of the apparatus information in the apparatus information acquisition unit 202 and the apparatus information transmission unit 204 are not particularly limited. The acquisition timing and the transmission timing may be successively transmitted after the acquisition, or the acquisition and the transmission maybe performed at separate timings. The acquisition and the transmission may be periodically performed, may be performed in response to a request from, the electric power retailer server 30 or the cloud, server 40, or may be performed, when another trigger, for example, information is acquired indicating that an abnormality has occurred in the amount of consumption of electric power or in the electric power-related apparatus. Furthermore, the communication apparatus 200 may have a configuration allowing the timing to be set.

The acquisition timing of the apparatus information in the apparatus information acquisition unit 202 may be the same as the timing at which the measurement value related to the amount of electric power is received from the electric power meter 10. Furthermore, the transmission timing of the apparatus information in the apparatus information transmission unit 204 may be the same as the timing at which the information related to the amount of electric power is transmitted to the electric power retailer server 30 or the cloud server 40 that is the second destination.

A method of controlling the communication apparatus 200 according to the present exemplary embodiment, which is configured in this manner, will be described below.

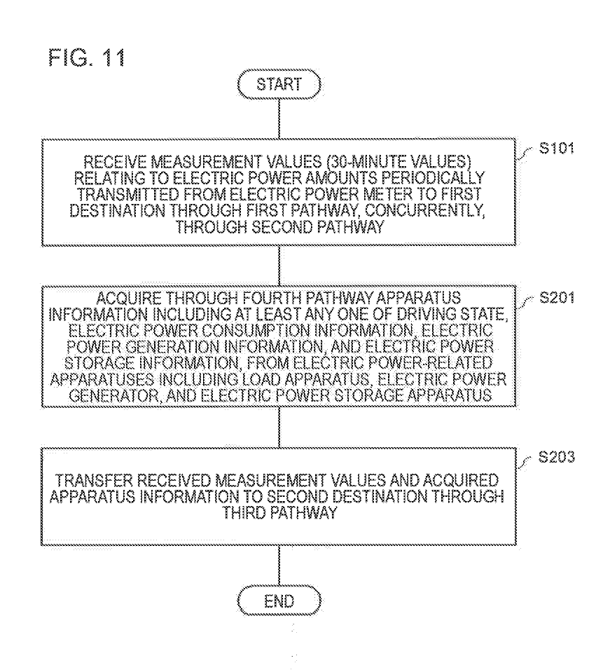

FIG. 11 is a flowchart illustrating an example of operation of the communication apparatus 200 according to the present exemplary embodiment.

The control method according to the exemplary embodiment of the present invention is for controlling the communication apparatus 200, and is performed by the computer 260 which implements the communication apparatus 200.

In the control method according to the present exemplary embodiment, the communication apparatus 200 receives the measurement value related to the amount of electric power from the electric power meter 10 (step S101), acquires the apparatus information from the electric power-related apparatus (Step S201), and transfers the received measurement value and the acquired apparatus information to the second destination (Step S203).

In detail, the reception unit 102 receives measurement values (30-minute values) related to amounts of electric power, which are periodically transmitted to the first destination (the electric power company server 20 or the like) through the first pathway (Routs A), from the electric power meter 10 through the second pathway (Route B) that is different from the first pathway (Step S101).

Then, the apparatus information acquisition unit 202 acquires, through the fourth pathway, the apparatus information that includes at least any one of information related to a driving state, information related to electric power consumption, information related to electric power generation, and information related to electric power storage, from the electric power-related apparatuses (including the electric power measurement apparatus 50 in FIG. 9) that include at least any one of a load apparatus 54, an electric power generator (a solar panel 52 in FIG. 9), and an electricity storage apparatus (a storage battery 56 in FIG. 9) (Step S201).

Then, the transfer unit 104 transfers the received measurement value to the second destination (the electric power retailer server 30, the cloud server 40, or the like) that is different from the first destination, through the third pathway (Route C) that is different from the second pathway, and the apparatus information transmission unit 204 transmits the apparatus information, which is acquired by the apparatus information acquisition unit 202, to the second destination through the third pathway (Step S203).

As described above, in the communication apparatus 200 according to the present exemplary embodiment, the apparatus information acquisition unit 202 acquires the apparatus information from, the electric power-related apparatus, and the apparatus information transmission unit 204 transmits the apparatus information, in addition to the measurement value, to the second destination through the third pathway.

Accordingly, the driving state, the information related to consumption of electric power, electric power generation, and electric power storage of the electric power-related, apparatus, as well as the measurement value related to electric power, can be transmitted to the electric power retailer server 30 or the cloud server 40 that is the second destination. Therefore, according to the communication apparatus 200 of the present exemplary embodiment, the same effect as in the exemplary embodiments described above is achieved, and the electric power retailer server 30 or the cloud server 40 is able to collect, in real time, the driving state, and the information related to consumption of electric power, electric power generation, and electric power storage of the electric power-related apparatus, as well as the measurement value related to the electric power.

As a result, each of the measurement values related to electric power consumption may be specifically associated with each particular one of the load devices 54. More precisely, the load apparatus 54 that consumes a large amount of electric power and the load apparatus 54 that consumes a small amount of electric power can be recognized. These pieces of information are also useful for Demand Response (DR) which, will be described below, and the like.

More precisely, the communication apparatus 100 can acquire an integrated value of the electric power consumption values for every 30 minutes from the measurement values related to the electric power consumption amounts, acquired from the electric power meter 10. Furthermore, the communication apparatus 100 can identify the amount of consumption of electric power, an amount of electric power generation by the electric power generator, or amounts of charge and discharge of the storage battery in each of the load apparatuses, with respect to a total amount, that is the integrated value of the consumption of electric power for every 30 minutes through, the third pathway.

### Fifth Exemplary Embodiment

Next, a communication apparatus according to a fifth exemplary embodiment of the present invention, and a method of controlling the communication apparatus will be described below. Note that a program according to the present exemplary embodiment causes at least one computer to perform the method of controlling the communication apparatus in the same manner as in the exemplary embodiments described above, and chat a detailed description thereof is omitted in the present exemplary embodiment.

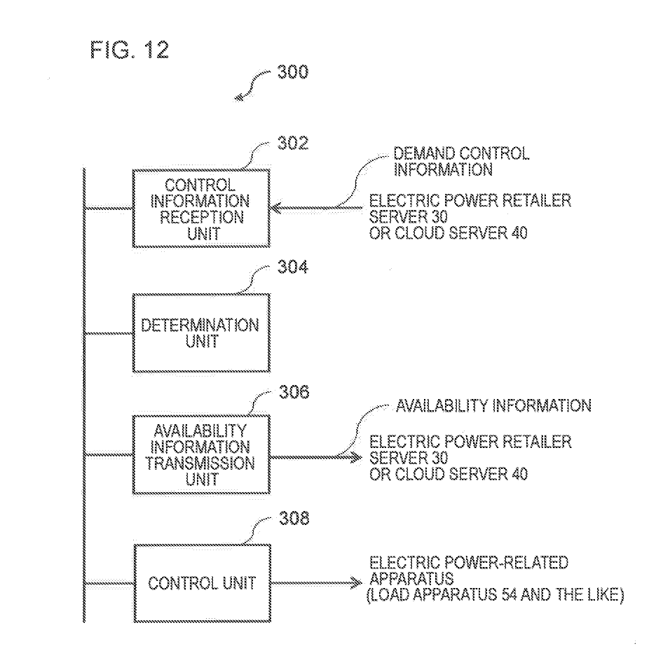

FIG. 12 is a functional block diagram logically illustrating a main configuration of a communication apparatus 300 according to the exemplary embodiment of the present, invention.

The communication apparatus 300 according to the present exemplary embodiment is different from the communication apparatus 200 according to the exemplary embodiment described with reference to FIG. 8, in that the communication apparatus 300 is configured to receive electric power demand, control information and to control the electric power-related apparatus,

Note that the communication apparatus 300 according to the present exemplary embodiment is described as an example that results from a combination with the configuration of the communication apparatus 200 in FIG. 8, but can result from a combination with a configuration of at least one of the communication apparatuses according to other exemplary embodiments that will be described below.

The communication apparatus 300 according to the present exemplary embodiment has the same configuration (which is not illustrated in FIG. 12) as the communication apparatus 200 according to the exemplary embodiment, which is described above, and further includes a control information reception unit 302, a determination unit 304, an availability information transmission unit 306, and a control unit 308.

Note that the communication apparatus 300 according to the present exemplary embodiment has the same configuration as the hardware configuration of the communication apparatus 200 according to the exemplary embodiment, which is described above with reference to FIG. 10.

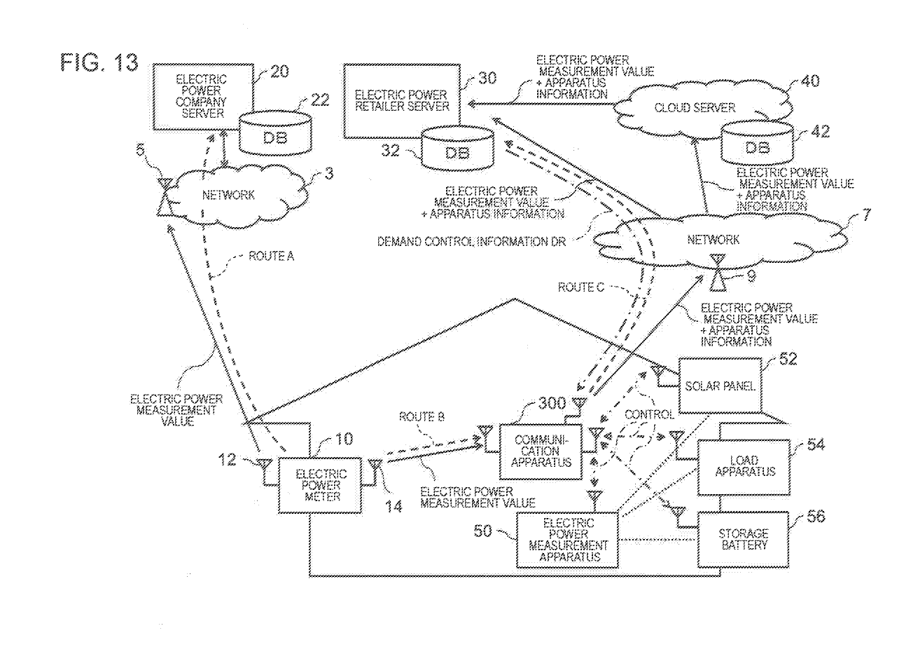

Furthermore, FIG. 13 is a diagram illustrating an example of a configuration of a communication system that uses the communication apparatus 300 according to the exemplary embodiment of the present invention.

The configuration of the communication apparatus 300 will be described with reference to FIG. 10, FIG. 12, and FIG. 13.

In the communication apparatus 300 according to the present exemplary embodiment, the control information reception unit 302 receives the electric power demand control information through the third pathway (Route C).

The determination unit 304 determines whether or not to perform electric power demand control that is based on the received demand control information.

The availability information transmission unit 306 transmits availability information of whether or not electric power demand control is performed that is determined, by the determination unit 304, to the second destination (the electric power retailer server 30 or the cloud server 40) through the third pathway.

Based on the demand control information, the control unit 308 instructs the electric power-related apparatus to control at least one of a driving operation, consumption of electric power, electric power generation, and electric power storage, through the fourth pathway.

Note that the communication apparatus 300 according to the present exemplary embodiment is implemented by the same computer as the computer 260 (FIG. 10) that implements the communication apparatus 200 according to the present exemplary embodiment, which is described above.

Here, according to the present invention, the demand control information is information for controlling electric power demand, that is presented by an electric power supply source, an electric power retailer, or the like to an electric power consumption side. The demand control information, for example, includes at least one piece of information out of; information on an electricity price that is exchanged with the electric power supply source in advance at the time of the contract (price setting for each time zone, limitation on usage time or on an amount of usage, or the like); and information related to a fuel cost adjustment amount, information related to an electric power outage or a planned electric power outage (time, area, estimated point in time for restoration, and the like), and a so-called “Demand Response (DR),” which sire issued from the electric power supply source.

Here, the “Demand Response” is defined as follows, in Assessment of Demand Response & Advanced Metering, Federal Energy Regulatory Commission (FERC) (2011), in U.S.A. Demand Response is defined as “Changes in electric usage by end-use consumers from their normal consumption patterns in response to changes in the price of electricity over time, or to incentive payments designed to induce lower electricity use at times of high wholesale market prices or when system reliability is jeopardized.”

Furthermore, the electric power supply source can refer to at least any one of an electric power company that is an electricity business operator, a so-called “aggregator” that adjusts electric power from plural electric power companies and supplies the adjusted electric power to a consumer, an electric power generator, and a system management organization, but may be a system, that has a mechanism which supplies the electric power to the consumer and is not limited thereto.

The demand control information may be received by the electric power meter 10 from the electric power company through the first pathway and transferred to the communication apparatus according to the present invention through the second pathway, or may be received directly by the communication apparatus according to the present invention from the electric power retailer or the like through the third pathway.

In the present specification, the demand control information is received directly by the communication apparatus according to the present invention from the electric power retailer server 30 or the cloud server 40.

According to the present exemplary embodiment, the demand control information is transmitted from the electric power retailer server 30 to the communication apparatus 300 through the third pathway (Route C). Alternatively, in response to a request from the electric power retailer, the cloud server 40 may transmit the demand control information to the communication apparatus 300. Furthermore, the demand, control information is assumed to be notified as a demand control event, to the consumer.

According to the present exemplary embodiment, the demand control information may be set by the electric power retailer server 30 or the cloud server 40, based on the measurement value and the apparatus information.

Furthermore, it is preferable that the amount of consumption of electric power to be suppressed in the demand control information is set in accordance with the consumption of electric power in the load apparatus 54 (FIG. 13) of the consumer, the charging amount of the storage battery 56 (FIG. 13), or the power generation amount of the electric power generator (the solar panel 52 in FIG. 13).

That is, the demand control information may be set by the electric power retailer server 30 or the cloud server 40, in such a manner that the larger at least any one of the electric power consumed by each load apparatus 54, the magnitude of the amount of electric power generated by the electric power generator (the solar panel 52), and the charging amount in the electricity storage apparatus (the storage battery 56), is, the larger the power usage amount to be reduced is.

As described above in the exemplary embodiments, the electric power retailer server 30 or the cloud server 40 can set the demand control information based on the measurement value or the apparatus information that is transferred from the communication apparatus 300.

The control information reception unit 302 connects to the network 7 using the second communication unit 72 and the second antenna 73 in FIG. 10, and receives the electric power demand control information from a transmission source, such as the electric power retailer server 30 or the cloud server 40, through the third pathway (Route C).

The timing at which the demand control information is received, for example, from the transmission source to the consumer side may be spontaneous, periodic, at a predetermined point in time, or at an emergency. Alternatively, information is transmitted, from the communication apparatus 300 to the transmission source, periodically, at a predetermined point in time, at the time of an arbitrary inquiry from the consumer, after an elapse of time from transmission or reception of information, before or after electric power control processing in the communication apparatus 300, or the like, but the transmission of information is not limited thereto.

The determination unit 304 determines whether or not to perform the electric power demand control that is based on the received demand control information.

Various methods of determining whether or not to perform the demand control are considered. Descriptions thereof are provided as follows, but there is no limitation thereto.

<1> A setting of an availability determination criterion set by the consumer or determined in advance at the time of a service provision contract is stored, and whether or not to perform, the demand control is determined automatically according to such criterion.

For example, a case is described where the demand control information includes content indicating that the electricity price is low when the amount of use of electric power at a certain time zone is made equal to or smaller than a predetermined value.

The consumer provides a setting as a criterion for imposing a demand limitation in advance, using at least one condition, or a combination, of at least two conditions, out of a time zone, a limitation value of the amount of use of electric power, a discount rate of the electricity price, an amount of incentive provision, and the like. Furthermore, the consumer may set, for each time zone, which one of the limitation value of the amount of use of electric power and the discount rate of the electricity price, and the amount of incentive provision is to be prioritized. For example, for the daytime, the limitation value of the amount of use of electric power may have the highest priority, while the demand limitation is imposed only in a case where the amount of electric power usage does not fall below a value which, the consumer thinks is necessary. On the other hand, for the nighttime, the priority of the limitation on the amount of electric power usage may be set low, and within a predetermined time zone in the nighttime, all demand limitations may be imposed regardless of the condition.

<2> A detail of the received demand control information is provided to the consumer, the consumer is inquired regarding whether or not to perform demand control, an input of an instruction on whether or not to perform the demand control is received from the consumer, and whether or not to perform the demand control is determined according to the received instruction. Various methods of providing information and various methods of receiving the instruction are considered and are described, as follows, but there is no limitation thereto.

(i) The detail of the received demand control information is displayed on the display unit of the communication apparatus 300 and the instruction on whether or not to perform, the demand control is input and is accepted using an operation unit.

(ii) A message is transmitted to and displayed on an in-Home Display (IHD) (not illustrated) of the HEMS (not illustrated) that is able to communicate with the communication apparatus 300, and the instruction on whether or not to perform demand control is input and is accepted through the HEMS to be received by the communication apparatus.

Note that a configuration in which a message is transmitted to a mail address of a user's mobile terminal, personal computer, or the like is not excluded, either.

The availability information transmission unit 306 connects to the network 7 using the second communication unit 72 and the second antenna 73 in FIG. 10, and transmits the availability information determined by the determination unit 304 to the second destination (electric power retailer server 30 or cloud, server 40) through the third pathway (Route C).

The availability information, for example, includes at least any one piece of information, of information indicating that the consumer has checked the demand control information, information on whether or not to impose the demand limitation, and, when plural demand limitation events are present, information indicating which one of the events the consumer will participate in.

The control unit 308 connects to the electric power-related apparatus using the third communication unit 74 and the third antenna 75 in FIG. 10, and, based on the demand control information that results from determining to perform the demand control, instructs each electric power-related apparatus to control at least one of the driving operation, the consumption of electric power, the electric power generation, and the electric power storage, through the fourth pathway.

For example, in order to cope with the planned electric power outage in the daytime, operation of the solar panel 52 and the storage battery 56 that are connected to the communication apparatus 300 can be controlled based on the demand control information.

A method of controlling the communication apparatus 300 according to the present exemplary embodiment, which is configured in this manner, will be described below.

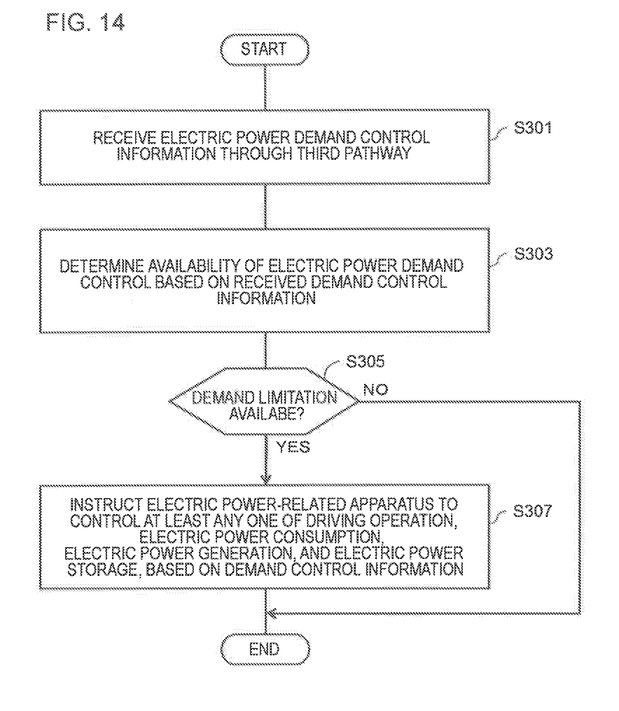

FIG. 14 is a flowchart illustrating an example of operation of the communication apparatus 300 according to the present exemplary embodiment.

The control method according to the exemplary embodiment of the present invention is a method of controlling the communication apparatus 300, and is a control method that is performed by the computer 260 which implements the communication apparatus 300.

First, the control information reception unit 302 receives the electric power demand control information through the third pathway (Route C) (Step S3 01).

Then, the determination unit 304 determines whether or not to perform the electric power demand control that is based on the received demand control information (Step S303). In a case where it is determined that the demand limitation is performed (YES in Step S305), based on the demand control information, the control unit 308 instructs the electric power-related apparatus to control at least one of the driving operation, the consumption of electric power, the electric power generation, and the electric power storage, through the fourth pathway (Step S307). Furthermore, the availability information transmission unit 306 transmits the availability information that is determined by the determination unit 304, to the second destination (the electric power retailer server 30 or the cloud server 40) through the third pathway (this is not illustrated). In a case where it is determined that the demand limitation is not performed (NO in Step S305), the present processing is ended.

As described, above, in the communication, apparatus 300 according to the exemplary embodiment of the present invention, the control information reception unit 302 receives the demand control information through the third pathway, and determines whether or not to perform the electric power demand control that is based on the demand control information which is received by the determination unit 304. Then, the availability information transmission unit 306 transmits the availability information to the second, destination through the third pathway, and, based on the demand control information, the control unit 308 instructs the electric power-related apparatus to control at least one of the driving operation, the consumption of electric power, the electric power generation, and the electric power storage, through the fourth pathway.

Accordingly, the electric power retailer server 30 or the cloud server 40 can directly notify the consumer of the electric power demand control information. Then, the consumer can receive the demand control information from the electric power retailer server 30 or the cloud server 40 through the communication apparatus 300. Therefore, with the communication apparatus 300 according to the present exemplary embodiment, the same effect as in the exemplary embodiments described above is achieved, and additionaly, the electric power retailer can make a request to the consumer for demand adjustment according to a state of electric power supply, and is able to suitably perform the demand 1 imitation in an efficient manner. Furthermore, based on the demand control information, the consumer can suitably control the amount of consumption of electric power in an efficient manner, and is able to keep the electricity price lowered or to maintain an amount of electric power supply that is comparatively stable even at the time of the planned electric power outage.

As described in the fourth exemplary embodiment, the electric power retailer server 30 or the cloud server 40 can identify the measurement value related to the consumption of electric power that is the electric-power integrated-value every 30 minutes for each consumer, and the amount of consumption of electric power for each load apparatus.

According to the present exemplary embodiment, the amount of consumption of electric power that is suppressed in the demand control information is set in response to the consumption of electric power in the load apparatus by the consumer, the amount of charge in the storage battery, or the amount of electric power generation in the electric power generator.

As a result, based on the amount of consumption of electric power for each consumer every 30 minutes and the consumption of electric power by each apparatus, the electric power retailer server 30 or the cloud server 40 can transmit the demand control information that is appropriate for each consumer.

In detail, since the consumer who uses a load of an electric apparatus or the like that, is able to be limited, in electric power demand, such as an air conditioner can be identified, the amount of electric power supply can be maintained in an,efficient manner by transmitting the demand control information for suppressing the consumption of electric power to the consumer.

In addition to what is described above, suppression of the consumption of electric power can be expected by determining a consumer who consumes a large amount of electric power, a consumer who has a storage battery with a large amount of charge, and a consumer who has a large amount of Photo Voltaics (FY) electric power generation. Thus, the demand control information for increasing the consumption of electric power that is suppressed is transmitted to the consumer, a target apparatus is controlled or is caused, to use discharge from the storage battery or electric power that is PV-generated, without using electric power from a system, and thus the consumption of electric power may be suppressed.

On the other hand, the suppression of the consumption of electric power cannot be expected from a consumer who has a small amount of consumption of electric power, a consumer who has a small amount of charge of the storage battery, and a consumer who has a small amount of PV electric power generation. Thus, the demand control information for in creasing the consumption, of electric power that is suppressed may be transmitted to the consumer.

### Sixth Exemplary Embodiment

Next, a communication apparatus according to a sixth exemplary embodiment of the present invention, and a method of controlling the communication apparatus will be described below. Note that a program according to the present exemplary embodiment causes at least one computer to perform, the method of controlling the communication apparatus in the same manner as in the exemplary embodiments described above, and that a detailed description thereof is omitted in the present exemplary embodiment.

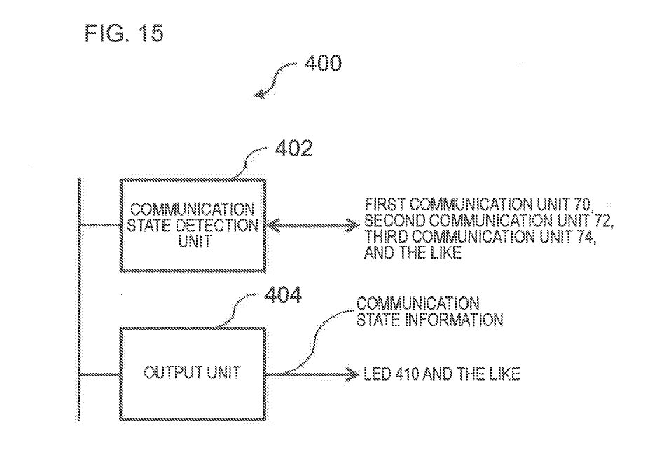

FIG. 15 is a functional block diagram logically illustrating a main configuration of a communication apparatus 400 according to the exemplary embodiment of the present invention.

The communication apparatus 400 according to the present exemplary embodiment is different from the communication apparatus 200 according to the exemplary embodiment, which is described with reference to FIG. 8, in that the communication apparatus 400 has a configuration in which communication states in the second, third, and fourth communication pathways are detected, and the communication states are output.

Note that the communication apparatus 400 according to the present exemplary embodiment is described as an example that results from combination with the configuration of the communication apparatus 200 in FIG. 8, but can result from combination with a configuration of at least any one of the communication apparatuses according to other exemplary embodiments that are described above and will be described below.

The communication apparatus 400 according to the present exemplary embodiment has the same configuration (which is not illustrated in FIG. 15) as the communication apparatus 200 according to the exemplary embodiment, which is described above, and further includes a communication state detection unit 402 and an output unit 404.

Note that the communication apparatus 400 according to the present exemplary embodiment is implemented by the same computer as the computer 260 (FIG. 10) that implements the communication apparatus 200 according to the present exemplary embodiment, which is described above.

The communication apparatus 400 according to the present exemplary embodiment has portability.

The communication state detection unit 402 detects each of the communication states in the second pathway (Route B) through which communication with the electric power meter 10 is performed, the third pathway (Route C) through which communication with the second destination is performed, and the fourth pathway through, which communication with the electric poser-related apparatus is performed.

The output unit 404 outputs the detected communication state.

For example, the output unit 404 outputs the information that all detected communication states of the second pathway, the third pathway, and the fourth pathway are satisfactory, the information, that, among the second pathway, the third pathway, and the fourth pathway, the communication state of at least one pathway is abnormal, or the like.

According to the present exemplary embodiment, in the communication apparatus 400, electric power is supplied from a built-in battery or rechargeable battery, or a plug socket through an Alternating Current (AC) adapter that is connected to the plug socket, which is not illustrated.

The communication state detection unit 402 detects each of the communication states in the first communication unit 70, the second communication unit 72, and the third communication unit 74 in FIG. 10.

The communication state includes information indicating a radio wave level (a signal strength) of a reception radio wave in the first antenna 71, the second antenna 73, and the third antenna 75 in FIG. 10, an occurrence of a timeout due to the presence or absence of a response, or a delay thereof at the time of communication in the first communication unit 70, the second, communication unit 72, and the third communication unit 74, an occurrence of a communication error due to continuous reception of data in a non-support format, or invalid data, or the like, and the like.

A timing of the detection of the communication state by the communication state detection unit 402 may be a periodic timing, a timing at which an instruction by the user is received, or a combination of these timings.

The output unit 404 displays information indicating that, along with the communication state of each pathway, the communication states of all the pathways are satisfactory, or at least one communication state is abnormal, on the display unit of the communication apparatus 400.

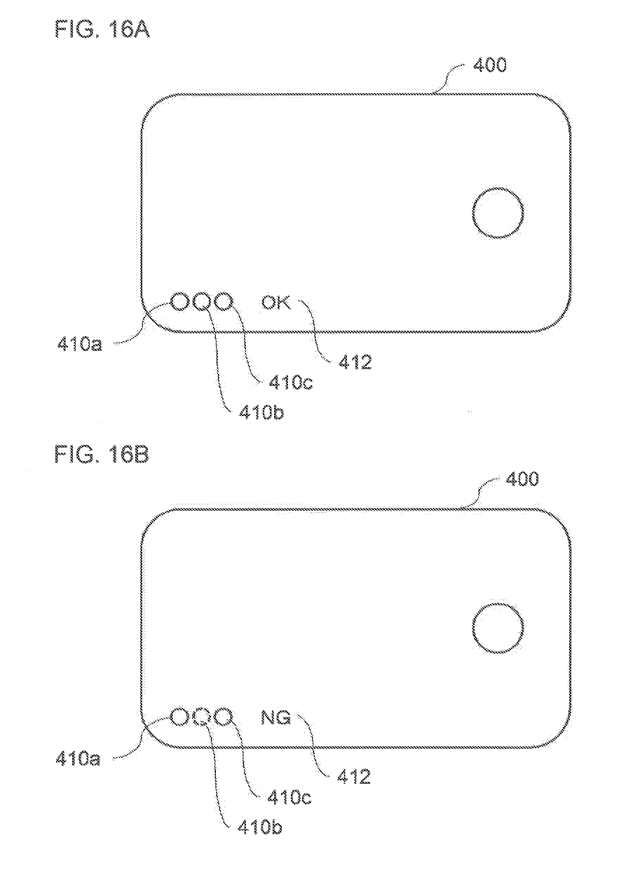

FIG. 16 are diagrams illustrating an example of output of the communication state by the output unit 404 of the communication apparatus 400 according to the present exemplary embodiment.

In FIG. 16, an example of the display by the output unit 404 is illustrated, but there is no limitation thereto. Output forms include forms other than the display, such as audio and vibration. Various output, timings may be considered, and, for example, may include a timing at which it is detected that the communication states of all the pathways are satisfactory or that at least one communication state is abnormal, a timing at which the communication apparatus 400 is installed, a timing of a checking operation by the user, a timing of repetition or the like within a predetermined time at a predetermined time interval, and combinations of these timings.

The communication states of three communication pathways, for example, are indicated, by three LEDs, that is, LEDs 410a, 410b, and 410c, respectively, which are installed on a front panel of the communication apparatus 400. Each LED may notify the user of the communication state, for example, by illuminating in a case where the communication state is satisfactory, by flashing in a case where an abnormality occurs, and by lighting-off in a case where connection cannot be ensured. Alternatively, the communication state may be displayed in luminescent color of the LED. Each LED may be caused to emit green light in the case where communication state is satisfactory, yellow light in the case where an abnormality occurs, and red light in the case where the connection cannot be ensured.

Additionally, in a case where the communication states of all the communication pathways are satisfactory, as illustrated in FIG. 16A, a message or a mark, such as “OK” or the like, which indicates the satisfactory state may be displayed on a communication state notification unit 412.

In an example in FIG. 16B, because the abnormality occurs on the second communication pathway, the LED 410b provides flashing and lighting, and a message or a mark, such as “NG” or the like, which indicates that, the abnormality occurs on at least one communication pathway, is displayed on the communication state notification unit 412.

As described above, in the communication apparatus 400 according to the present exemplary embodiment, the communication state detection unit 402 detects the communication state of each communication pathway, and the output unit 404 notifies the user of the communication state. With this function, for example, in a case where the communication apparatus 400 is installed inside a home, the user checks whether or not a place where the communication states of all three communication pathways are satisfactory, and thus can install the communication apparatus 400 in a suitable place, or, in a case where the communication state deteriorates or the like, can change the installation place to a place where the communication state is satisfactory.

Then, a place where the radio wave state is satisfactory is searched for. When an installation place is determined, electric power is supplied from a near plug socket to the communication apparatus 400, but the power may be supplied using a battery chat is built into the communication apparatus 400.

### Seventh Exemplary Embodiment

Next, a communication apparatus according to a seventh exemplary embodiment of the present invention, and a method of controlling the communication apparatus will be described below. Note that a program according to the present exemplary embodiment causes at least one computer to perform the method of controlling the communication apparatus in the same manner as in the exemplary embodiments described above, and that a detailed description thereof is omitted in the present exemplary embodiment.

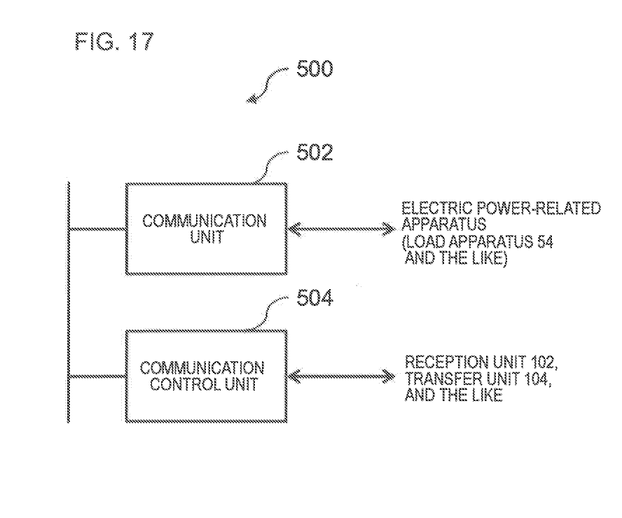

FIG. 17 is a functional block diagram logically illustrating a main configuration of a communication apparatus 500 according to the exemplary embodiment of the present invention.

The communication apparatus 500 according to the present exemplary embodiment is different from the communication apparatus 100 according to the exemplary embodiment, which, is described with reference that is, FIG. 2, in that the communication apparatus 500 can communicate with the electric power-related apparatus, and, in a case where it cannot be determined that the own apparatus is present in a predetermined place (inside of a residence or the like), has a configuration in which the communication with the electric power meter is performed.

Note that the communication apparatus 500 according to the present exemplary embodiment is described as an example that results from combination with the configuration of the communication apparatus 100 in FIG. 2, but can result from the combination with the configuration of at least any one of the communication apparatuses according to other exemplary embodiments that will be described below.

The communication apparatus 500 according to the present exemplary embodiment has the same configuration (which is not illustrated in FIG. 17) as the communication apparatus 100 according to the exemplary embodiment, which is described above, and further includes a communication unit 502 and a communication control unit 504.

Note that the communication apparatus 400 according to the present exemplary embodiment is implemented by the same computer as the computer 260 (FIG. 10) that implements the communication apparatus 200 according to the present exemplary embodiment, which is described above.

In the communication apparatus 500 according to the present exemplary embodiment, the communication unit 502 communicates with the electric power-related apparatuses that include at least any one of the load apparatus 54, the electric power generator (the solar panel 52), and the electricity storage apparatus (the storage battery 56), which are installed in a predetermined, site where the amount of consumption of electric power by the electric power meter 10 is measured.

In a case where communication with the electric power-related apparatus is established by the communication unit 502, the communication control unit 504 performs communication with the electric power meter 10.

At this point, the electric power-related apparatuses with which the communication unit 502 communicates include at least one of a load apparatus, an electric power generator, an electricity storage apparatus, a home electric power distribution board, an HEMS, a user's smartphone, a dedicated authentication card, and a server (the electric power retailer server 30 or the cloud server 40) and excludes the electric power meter 10 and the like.

The configuration according to the present exemplary embodiment is for preventing, in a case where the communication apparatus 500 of the present invent i on is in the form of a portable terminal, illegal theft of information of the electric power meter 10 where the apparatus is taken out of the home due to a burglary or the like. Therefore, the electric power-related apparatus must be an apparatus that can indicate that the communication apparatus 500 is present within a predetermined site, for example, within the consumer's residence, and excludes the electric power meter 10 and the like that are installed outside of the consumer's residence.

The communication control unit 504 ensures the communication with the electric power-related apparatus, which is set in advance. Various conditions for performing or not performing the communication with the electric power meter 10 are considered, and are described as follows, but there is no limitation thereto.

(c1) Communication with the electric power meter 10 is approved only when communication with all electric power-related apparatuses is confirmed. Communication with the electric power meter 10 is not performed when even one electric power-related apparatus with which the communication cannot be ensured is present.

(c2) Communication with the electric power meter 10 is approved when communication with at least one electric power-related apparatus is confirmed.

In a case where communication cannot be confirmed for any electric power-related apparatus, communication with the electric power meter 10 is not performed.

(c3) Communication with the electric power meter 10 is approved when only when communication with the HEMS is confirmed.

In a case where the communication with the electric power-related apparatus cannot be confirmed, various types of processing that do not allow communication with the electric power meter 10, that is, various types of processing that prohibit communication with the electric power meter 10 by the communication control unit 504 may be considered, and are described below. Furthermore, the following processing may all be prohibited, or only the processing that is selected according to a condition or a setting may be prohibited or approved.

(d1) Stopping reception by the reception unit 102 of the measurement value related to the amount of electric power from the electric power meter 10.

(d2) Stopping transfer by the transfer unit 104 of the measurement value related to the amount of electric power to the second destination.

(d3) Stopping communication function of at least any one of the first communication unit 70, the second communication unit 72, and the third communication unit 74 in FIG. 10.

(d4) Stopping acquisition of the apparatus information by the apparatus information acquisition unit 202.

(d5) Stopping transmission of the apparatus information by the apparatus information transmission unit 204 to the second destination.

Additionally, not only the performance of the communication with the electric power meter 10 may be stopped, but the communication control unit 504 may also delete the information related to the amount of electric power and the apparatus information that are retained in the ROM 64 or the RAM 66 in FIG. 10, of the communication apparatus 500.

Operation of the communication, apparatus 500 according to the present exemplary embodiment, which is configured in this manner, will be described below.

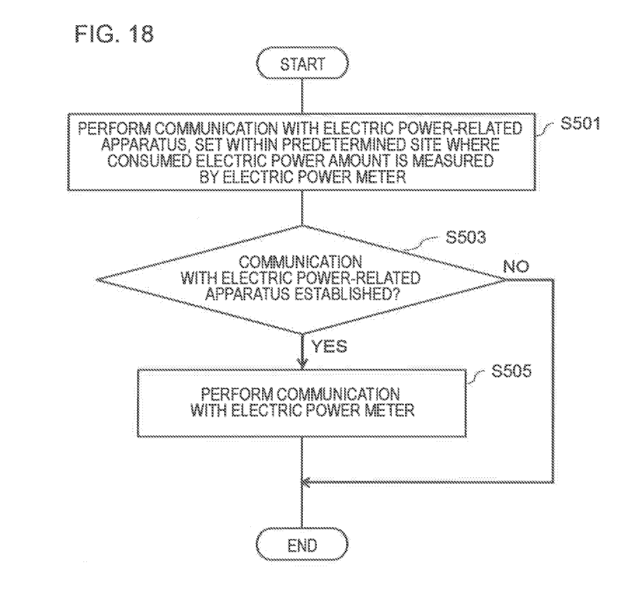

FIG. 18 is a flowchart illustrating an example of operation of the communication apparatus 500 according to the present exemplary embodiment.

First, in the communication apparatus 500, the communication unit 502 communicates with the electric power-related apparatus, which is installed in a predetermined site where the amount of consumption of electric power is measured by the electric power meter 10 (Step S501).

Then, the communication control unit 504 checks the establishment of communication with the electric power-related apparatus (Step S503). In a case where communication with the electric power-related apparatus is established (YES in Step S503), the communication control unit 504 communicates with the electric power meter 10 (Step S505). In a case where communication with the electric power-related apparatus is not established (NO in Step S503), the present processing is ended and communication with the electric power meter 10 is not performed.

Note that various timings at which the processing flow is executed may be considered, and for example, include a periodic timing, a setting timing, and the like. Furthermore, in a case where communication with the electric power-related apparatus is not established (NO in Step S503) and communication with the electric power meter 10 is already being performed, at least one type of the above mentioned processing of (d1) to (d5) may be performed.

As described above, in the communication apparatus 500 according to the present exemplary embodiment, the communication unit 502 communicates with a predetermined electric power-related apparatus, and in a case where the communication with the electric power-related apparatus can be performed, communication control unit 504 performs control in such a manner that the communication with the electric power meter 10 is performed.

Accordingly, with the communication apparatus 500 according to the present exemplary embodiment, the same effect as in the exemplary embodiments described above is achieved, and in a case where the communication apparatus 500 is taken out of a residence due to theft or the like, it is automatically detected that the communication apparatus 500 is not present inside of the residence and thus the communication with the electric power meter 10 can be canceled. Therefore, the information that is received from the electric power meter 10 can be protected.

### Eighth Exemplary Embodiment

Next, a communication system according to an eighth exemplary embodiment of the present invention will be described below.

The communication system according to the present invention includes the communication apparatus according to any of the exemplary embodiments, which is described above, and a server apparatus to which the communication apparatus transfers information such as measurement value. Note that the communication apparatus that transfers the information to the server apparatus may be a combination of plural different communication apparatuses according to the exemplary embodiment.

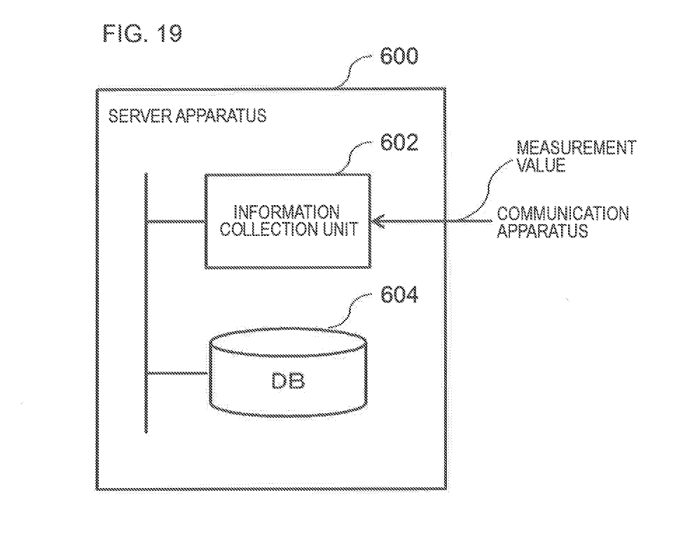

FIG. 19 is a functional block diagram logically illustrating a configuration, of a server apparatus 600 of the communication system according to the exemplary embodiment of the present invention.

In the communication system according to the present exemplary embodiment, the server apparatus 600 includes an information collection unit 602 that collects the measurement value of the electric power meter 10, which is transferred from at least one communication apparatus.

The measurement value that is collected by the information collection unit 602 is stored in a database 604.

The server apparatus 600 according to the present exemplary embodiment is equivalent to the electric power retailer server 30 or the cloud server 40 according to the exemplary embodiment, which is described above.

The server apparatus 600 according to the present exemplary embodiment can be implemented by a computer 660, such as a server computer, a personal computer, and a blade server in a data center or the like.

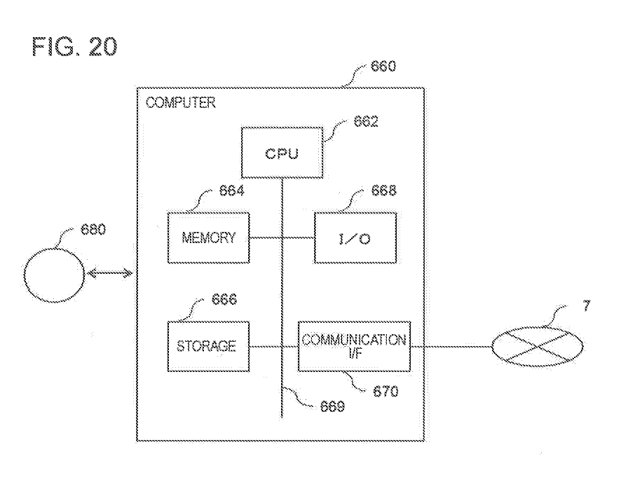

FIG. 20 is a block diagram illustrating an example of a configuration of the computer 660 that implements the server apparatus 600 according to the exemplary embodiment of the present invention.

The computer 66 0 includes a CPU 662, a memory 664, a program 680 that implements constituent elements in FIG. 19, which is loaded into the memory 664, a storage 666, such as a hard disk in which the program 680 is stored, an I/O 668, and a network connection interface (a communication interface (I/F) 670). The memory 664, the storage 666, the I/O 668, and the communication interface 670 are connected to one another through a bus 669, and the entire computer 660 is controlled by the CPU 662 along with each element.

Each constituent element 6f the server apparatus 600 in FIG. 19 is implemented by an arbitrary combination of hardware and software of the computer 660. Then, it is understood by a person of ordinary skill in the art that various modifications to a method of implementing each constituent element and apparatus are present. FIG. 19 illustrates a block in terms of a logical functional unit, not a configuration in terms of a hardware unit.

By reading and executing the program 680 that is stored in the storage 666, into the memory 664 for execution, the CPU 662 can implement a function of each of the units of the server apparatus 600 in FIG. 13.

Note that, in FIG. 20, a configuration of a portion that is not related to the nature of the present invention is not illustrated, and for example, a display unit, an operation unit, and the like are not illustrated.

A computer program according to the present exemplary embodiment is written in such a manner that the computer 660 for implementing the server apparatus 60 0 is caused to execute a procedure of collecting the measurement value of the electric power meter 10, which is transferred from at least one communication apparatus.

The computer program according to the present exemplary embodiment may be recorded on a computer readable recording medium. There is no limitation to the recording medium, and recording media in the various forms are considered. Furthermore, the program may be loaded from the recording medium into the memory of the computer, and may be downloaded on the computer through a network and may be loaded into the memory.

The recording media on which to record the computer program 680 include a non-transitory medium that is usable by the computer 660, and program, codes that are readable by the computer 660 is embedded into the medium. The computer program 680, when is executed on the computer 660, causes the computer 660 to perform a control method of implementing the server apparatus 600.

As described, above, in the communication system according to the present exemplary embodiment, the information collection unit 602 of the server apparatus 600 can receive the measurement value related to electric power, which is collected by the communication apparatus according to the present invention from the electric power meter 10, from the communication apparatus in real time.

The exemplary embodiments of the present invention are described above with reference to the drawings, but these are only examples of the present invention, and various configurations other that the configurations described above can be employed.

<Server Apparatus: Information Retransmission Request Processing>

A configuration is described in which, for example, in the communication apparatus 120 according to the exemplary embodiment in FIG. 7, in a case where there is a lack of the measurement value that is received from the electric power meter 10, the communication apparatus 120 requests the electric power meter 10 to perform the retransmission request. A configuration may be employed in which the server apparatus, instead of the communication apparatus 120, checks whether or not there is a lack of the measurement value.

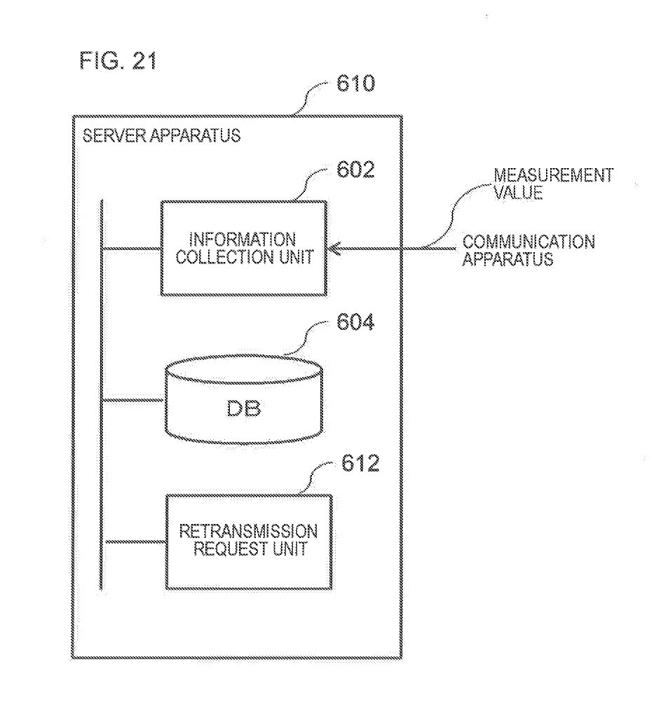

FIG. 21 is a functional block diagram logically illustrating a configuration of a server apparatus 610 according to the present exemplary embodiment.

The server apparatus 610 includes the server apparatus 600, the information collection unit 602, the database 604 that are the same as those of the server apparatus 600 in FIG. 20, and further includes a retransmission request unit 612.

The information collection unit 602 retains the measurement value of the electric power meter 10, which is received from the communication apparatus through the third communication pathway, in the database 604. In a case where, based on a result of determining whether or not there is a lack of the measurement value, it is determined that there is a lack of the measurement value, the retransmission request unit 612 instructs the communication apparatus to make a request to the electric power meter 10 for the retransmission of a part of the lack of the measurement value.

With this configuration, because on the server apparatus 610 side, it can be checked whether or not there is a lack of the measurement value of each electric power-meter 10, a load on the process on the communication apparatus can be reduced. Furthermore, since the server apparatus 610 can store information over a long period of time in the database 604, it can be determined whether a state of the lack of the measurement value is one that is temporary or one over the long term. For example, if the state is temporary, there is a high likelihood that the information can be acquired immediately by making the retransmission request. However, in a case where the state is one over the long term, even if the retransmission request is repeatedly made, there is a likelihood that the information could not be acquired immediately. When the retransmission request is repeated, there is a likelihood that a communication or processing load will be increased. By determining the lack of the measurement value in the server apparatus 610, the retransmission request can be suitably made, thereby reducing the load.

<Server Apparatus: Communication Charge Discount>

Next, an example of a business model that uses the communication apparatus according to the present invention is considered.

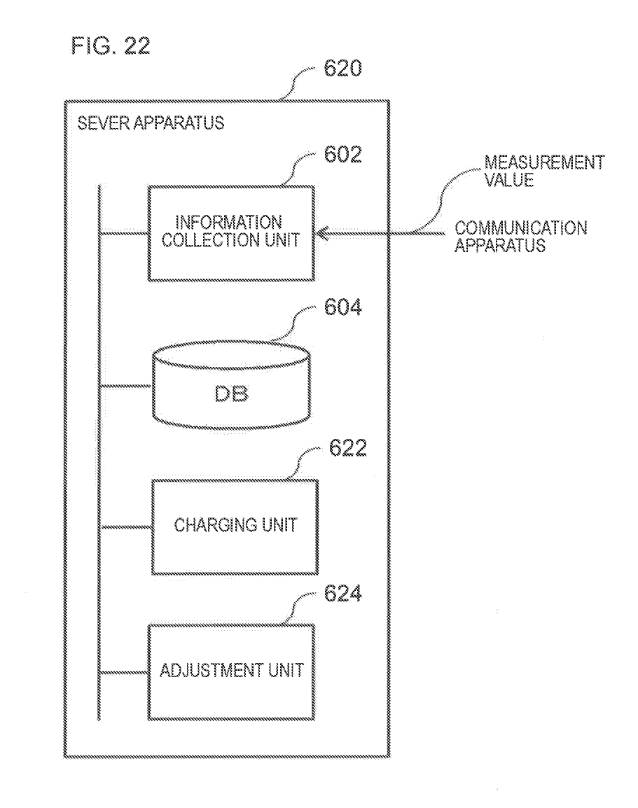

FIG. 22 is a functional block diagram logically-illustrating a configuration of a server apparatus 620 according to the present exemplary embodiment.

It is assumed that the server apparatus 620 according to the present exemplary embodiment, for example, is a server for a communication carrier. It is assumed that the communication apparatus according to the present exemplary embodiment uses a mobile communication network for the communication carrier as the third communication pathway.

According to the present exemplary embodiment, the server apparatus 620 includes a charging unit 622 that charges a communication apparatus a charge for the use of a communication service through the third communication pathway, and an adjustment unit 624 that provides a discount on the charge for the use of the communication service by the communication apparatus, or provides an incentive, in a case where the amount of consumption of electric power within a predetermined period, of time is equal to or larger than a predetermined value, based on the measurement value that is collected from the communication apparatus.

Furthermore, in a case other than the case where the amount of consumption of electric power is equal to or larger than the predetermined value, the adjustment unit 624 can provide a discount on the charge for the use of the communication service by the communication apparatus, or provide the incentive, by providing the measurement value related to the amount of electric: power or the apparatus information. Furthermore, the adjustment unit 624 applies a discount rate or an incentive provision rate according to the amount of consumption of electric power, and may provide the discount on the charge for the use of the communication service or the incentive.

The charge for the use of the communication service to be discounted, for example, includes a charge for the connection to the network 3 (for example, a mobile communication network or the Internet) that is made when the measurement value or the apparatus information is transmitted from the communication apparatus to the electric power retailer server 30 or the cloud server 40. Additionally, the charge for the use of the communication service to be discounted may include a connection charge or a usage charge, such as for use of communication other than the transmission of the measurement value or the apparatus information, for example, reading of a website or mobile site that connects to the Internet, or a mobile communication network, use of content, and use of various services.

Furthermore, the communication apparatus according to the present invention may have a function of a Wi-Fi router, and may be a target to which to provide a discount on the connection charge or the usage charge for the normal use of the communication, which is described above, by another terminal that uses the router function of the communication apparatus.

Alternatively, a charge (payment of a price of a terminal (or a charge for use of the terminal), a telephone call charge, a charge for a connection to the Internet (or a mobile communication network), a charge of use of content, a charge for use of various services, or the like) for use of the communication apparatus and a mobile communication terminal (a mobile telephone, a smartphone, a tablet terminal, a Wi-Fi router, or the like) may be a target to which to provide a discount.

Furthermore, the communication apparatus according to the present invention may have the function of the Wi-Fi 1 router or other functions (telephone conversation), in which case only the use of the communication apparatus may provide a discount on the charge for the use of the communication service, regardless of the amount of consumption of electric power.

With this configuration, the communication carrier can encourage the user to use the mobile communication network of the own communication carrier using communication using the communication apparatus through the third communication pathway, and, by providing the incentive, the communication carrier can urge the user who provides the measurement value, to use the mobile communication network of the own communication carries. On the other hand, receiving a discount on the charge for the use, or the incentive, in return for providing the measurement value is favorable for the user.

Furthermore, it is also considered that the communication carrier conducts electric power retail business, in which case the server apparatus 620 is the electric power retailer server 30. The server apparatus 620 (the electric power retailer server 30 ) can receive and collect the information of the electric power meter 10 through the communication that involves the mobile communication network of the communication carrier itself, from each communication apparatus. Furthermore, the communication carrier can provide the communication apparatus to the user on a pay or free-of-charge basis. Furthermore, the communication apparatus may be one that is possessed by the user, and may be one that is rented to the user,

The invention in the present application is described above with, reference to the exemplary embodiments and the implementation examples, but the invention in the present application is not limited to the exemplary embodiments and the implementation examples, which are described above. Various modifications that are understood by a person of ordinary skill in the art can be made to the configurations or the details of the invention in the present application within the scope of the invention in the present application.

Hots that it is assumed that, according to the present invention, in a case where information related to the user is acquired and is used, this acquisition and use are legitimate.

Examples of reference embodiment are described in the form of supplementary notes as follows.
1. A communication system including:

a communication apparatus, and

a server,

in which the communication apparatus includes

a reception unit that receives a measurement value related to an amount of electric power from an electric power meter, and

a transfer unit chat transfers the measurement value which is received from the electric power meter, to a destination that is different from the electric power meter,

in which the server includes

an information collection unit that collects the measurement value of the electric power meter, which is transferred from at least one communication apparatus.
2. The communication system according to (1),

in which, in the communication apparatus,

the reception unit receives the measurement value, which is periodically transmitted to a first destination through the first pathway, from the electric power meter through, a second pathway that is different from the first pathway, and

the transfer unit transfers the received measurement value to a second destination that is different from the first destination, through a third pathway that is different from the first pathway and the second pathway.
3. The communication system, according to (2),

in which the communication apparatus further includes

an apparatus information acquisition unit, that acquires apparatus information on each electric power-related apparatus from, a plurality of electric power-related apparatuses, and

a transmission unit that transmits the measurement value and the apparatus information to the second destination.

4. The communication system according to (3),

in which the plurality of electric power-related apparatuses include a load apparatus, an electricity storage apparatus, and an electric power generator, and

in which the apparatus information includes at least any one of a driving state, information on consumption of electric power related to the load apparatus, information on electric power storage related to the electricity storage apparatus, and information on electric power generation related to the electric power generator,
5. The communication system according to (3) or (4),

in which the communication apparatus further includes

a control information reception unit that receives electric power demand control information through the third pathway,

a determination unit that determines whether or not to perform electric power demand control that is based on the received demand control information,

a transmission unit that transmits availability information that is determined by the determination unit, to the second destination through the third pathway, and

a control unit that instructs the electric power-related apparatus to control at least any of a driving operation, consumption of electric power.

electric power generation, and electric power storage, through a fourth pathway, based on the demand control information.
6. The communication system according to (5), in which the demand control information is set based, on the measurement value and the apparatus information.
7. The communication system according to (6),

in which the electric power-related apparatus includes at least any one of the load apparatus, the electricity storage apparatus, and the electric power generator, and

in which the demand control information is set in such a manner that the larger at least any one of the consumption of electric power by each load apparatus, a magnitude of an amount of electric power generated by the electric power generator, and an amount of charge in the electricity storage apparatus is, the larger an amount of use of electric power to be suppressed is, 8. The communication system according to any one of (3) to (7),

in which the communication apparatus has portability, and.

the communication apparatus includes

a communication state detection unit that detects each of communication states in the second pathway communicating with the electric power meter, the third pathway communicating with the second destination, and a fourth pathway communicating with the electric power-related apparatus, and an output unit that outputs the communication state.
3. The communication system according to any one of (2) to (8)

further including a communication unit that communicates with electric power-related apparatuses which include at least any one of the load apparatus, the electric power generator, and the electricity storage apparatus, which are installed in a predetermined site where an amount of consumption of electric power is measured by the electric power meter, and

a communication control unit that performs the communication with the electric power meter in a case where communication with the electric power-related apparatus can be performed by the communication unit, 10. The communication system according to any one of (2) to (9),

further including

a storage unit that, stores in advance authentication information for authenticating each of the electric power meter and the second destination, and

an authentication unit that authenticates each of the electric power meter and the second destination by using the authentication information.
11. The communication system according to (10)

further including

an authentication information acquisition unit that acquires the information for authenticating the electric power meter from, the second destination through the third pathway,

in which the information for authenticating the electric power meter, which is acquired by the authentication information acquisition unit, is stored in the storage unit,
12. The communication system, according to any one of (2) to (11), in which the transfer unit performs transfer of the measurement value when the reception unit receives the measurement value from the electric power meter.
13. The communication system according to any one of (2) to (12), in which in the communication apparatus,

the transfer unit determines a transfer timing of the measurement value based on at least one of a storage capacity of the communication apparatus, a processing load on the communication apparatus, a communication state of the third pathway, and a processing load on an apparatus that is the second destination,
14. A method of controlling a communication apparatus, pea:formed by the communication apparatus, including:

receiving a measurement value related to an amount of electric power from an electric power meter, and

transferring the measurement value that is received from the electric power meter, to a destination that is different from the electric power meter,

15. The method of controlling a communication apparatus according to (14), in which the communication apparatus receives the measurement value, which is periodically transmitted to a first destination through a first pathway, from the electric power meter through a second pathway that is different from the first pathway, and

transfers the received measurement value to a second destination that is different from, the first destination, through a third pathway that is different from the first pathway and the second pathway.

16. The method of controlling a communication apparatus according to (15), performed by the communication apparatus, further including;

acquiring apparatus information on each electric power-related, apparatus from a plurality of electric power-related apparatuses; and

transmitting the measurement value and the apparatus information to the second, destination,
17. The method of controlling a communication apparatus according to (16),

in which the plurality of electric power-related apparatuses include a load apparatus, an electricity storage apparatus, and an electric power generator, and

in which the apparatus information includes at least any one of a driving state, information on consumption of electric power related to the load apparatus, information on electric power storage related to the electricity storage apparatus, and information on electric power generation related to the electric power generator.
18. The method, of controlling a communication apparatus according to (16) or (17), performed by the communication apparatus, further including:

receiving electric: power demand control information through the third pathway,

determining whether or not to perform electric power demand control that is based on the received demand control information,

transmitting availability information that has been determined, to the second destination through the third pathway, and

instructing the electric power-related apparatus to control at least any of a driving operation, consumption of electric power, electric power generation, and electric power storage, through a fourth pathway, based on the demand control information.
19. The method of controlling a communication apparatus according to (18), in which the demand control information is set based on the measurement value and the apparatus information.
20. The method of controlling a communication apparatus according to (19),

in which the electric power-related apparatus includes at least any one of the load apparatus, the electricity storage apparatus, and the electric power generator, and

in which the demand control information is set in such a manner that the larger at least any one of the consumption of electric power by every load apparatus, a magnitude of an amount of electric power generated by the electric power generator, and an amount of charge in the electricity storage apparatus is, the larger an amount of use of electric power to be suppressed is.
21. The method of controlling a communication apparatus according to any one of (16) to (20),

in which the own apparatus has portability, and

the method, performed by the communication apparatus, further includes:

detecting each, of communication states in the second pathway communicating with the electric power meter, the third pathway communicating with the second destination, and a fourth pathway communicating with the electric power-related apparatus, and.

out put ting the communication state.
22. The method of controlling a communication apparatus according to any one of (15) to (21),

performed by the communication apparatus, further including

communicating with electric power-related apparatuses which include at least, any one of the load apparatus, the electric power generator, and the electricity storage apparatus, which are installed in a predetermined site where an amount of consumption of electric power is measured by the electric power meter, and

performing communication with the electric power meter in a case where the communication with the electric power-related apparatus can be performed.
23. The method of controlling a communication apparatus according to any one of (15) to (22), performed by the communication apparatus, further including:

storing information for authenticating each of the electric power meter and the second destination in advance, and

authenticating each of the electric power meter and the second destination by using the authentication information.
24. The method of controlling a communication apparatus according to (23), in which the communication apparatus

acquires the information for authenticating the electric power meter from the second destination through the third pathway, and

stores the information for authenticating the electric power meter, which is acquired, in the storage unit.
25. The method of controlling a communication apparatus according to any one of (15) to (24), in which the communication apparatus performs transfer of the measurement value when the reception unit receives the measurement value from the electric power meter.
26. The method of controlling a communication apparatus according to any one of (15) to (25), in which the communication apparatus determines a transfer timing of the measurement value based on at least one of a storage capacity of the communication apparatus, a processing load on the communication apparatus, a communication state of the third pathway, and a processing load on an apparatus that is the second destination.
27. A program for causing a computer to execute

a procedure of receiving a measurement value related to an amount of electric power from an electric power meter, and

a procedure of transferring the measurement value that is received from the electric power meter, to a

destination that is different from the electric power meter,
28. The program according to (27), in which the computer is caused to execute

a procedure of receiving a measurement value, which is periodically transmitted to a first, destination through a first pathway, from an electric power meter through a second pathway that is different from the first pathway, and

a procedure of transferring the received measurement value to a second destination that is different from the first destination, through a third pathway that is different from the first pathway and the second pathway.
29. The program according to (28), in which the computer is further caused to perform

a procedure of acquiring apparatus information on each electric power-related apparatus from a plurality of electric power-related, apparatuses, and

a procedure of transmitting the measurement value and the apparatus information to the second destination.
30. The program according to (29), in which the plurality of electric power-related apparatuses include a load apparatus, an electricity storage apparatus, and an electric power generator, and in which the apparatus information includes at least any one of a driving state, information on consumption of electric power related to the load apparatus, information on electric power storage related to the electricity storage apparatus, and information on electric power generation related to the electric power generator.
31. The program according to (29) to (30), in which the computer is further caused to perform

a procedure of receiving electric power demand control information through the third pathway,

a procedure of determining whether or not to perform electric power demand control that, is based on the received demand control information,

a procedure of transmitting availability information that, has been determined, to the second destination through the third, pathway, and

a procedure of instructing the electric power-related apparatus to control at least any of a driving operation, consumption of electric power, electric power generation, and electric power storage, through a fourth pathway, based on the demand control information.
32. The program according to (31) in which the demand control information is set based on the measurement value and the apparatus information,
33. The program according to (32), in which the electric power-related apparatus includes at least any one of the load apparatus, the electricity storage apparatus, and the electric power generator, and in which the demand control information is set in such a manner that as at least any one of the electric power consumed by each load apparatus, a magnitude of an amount of electric power generation by the electric power generator, and an amount of charge in the electricity storage apparatus becomes larger, an amount of use of electric power, which is to be reduced, becomes larger.
34. The program according to any one of (29) to (33), in which the communication, apparatus has portability, and in which the computer is caused to perform

a procedure of detecting each of communication states in the second pathway communicating with the electric power meter, the third pathway communicating with the second destination, and a fourth pathway communicating with the electric power-related apparatus, and

a procedure of outputting the communication state.
35. The program according to any one of (28) to (34), in which the computer is further caused to perform

a procedure of communicating with electric power-related apparatuses which include at least any one of the load apparatus, the electric power generator, and the electricity storage apparatus, which are installed in a predetermined site where an amount of consumption, of electric power is measured by the electric power meter, and

a procedure of performing the communication with the electric power meter in a case where the communication with the electric power-related apparatus can be performed.
36. The program according to any one of (28) to (35), in which the computer is further caused to perform

a procedure of storing information for authenticating each of the electric power meter and the second, destination in advance, and

a procedure of authenticating each of the electric power meter and the second destination, by using the authentication information.
37. The program according to (36), in which the computer is further caused to perform

a procedure of acquiring the information for authenticating the electric power meter from the second destination through the third pathway, and

a procedure of storing the information for authenticating the electric power meter, which is acquired, in the storage unit,
38. The program according to any one of (28) to (37), in which in the procedure of transferring the received measurement value, the computer is further caused to perform a procedure of transferring the measurement value when the reception unit receives the measurement value from the electric power meter,
39. The program according to any one of (28) to (38), in which in the procedure of transferring the received measurement value, the computer is further caused to perform a procedure of determining a transfer timing of the measurement value based on at least one of a storage capacity of the communication apparatus, a processing load on the communication apparatus, a communication state of the third pathway, and a processing load on an apparatus that is the second destination.
40. A method of controlling a communication apparatus performed by the communication apparatus, including:

acquiring information for authenticating an electric power meter based on identification information on the communication apparatus,

performing authenticated connection to the electric power meter based on the authentication information,

receiving a measurement value related to an amount of electric power from, the electric power meter, and

transferring the measurement value which is received from, the electric power meter, to a destination that is different, from the electric power meter.
41. The method of controlling a communication apparatus according to (40), in which the communication apparatus receives the measurement value, which is periodically transmitted to a first destination through a first pathway by the electric power meter that is connected after the authentication, through a second pathway that is different from, the first pathway, and transfers the received measurement value to a second destination that is different from the first destination, through a third pathway that is different from the first pathway and the second pathway.
42. The method of controlling a communication apparatus according to (41), in which, the communication apparatus stores the information for authenticating the electric power meter, which is acquired by the authentication information acquisition unit from the second destination through the third pathway, in a storage unit, and performs authenticated connection to the electric power meter using the authentication information that is stored in the storage unit.
43. The method of controlling a communication apparatus according to (42), in which the communication apparatus acquires the information for authenticating the electric power meter based on identification information on the communication apparatus when the communication apparatus is powered on, and performs the authenticated connection to the electric power meter based on the acquired authentication information,
44. A program for causing a computer to perform

a procedure of acquiring information for authenticating an electric power meter based on identification information on the communication apparatus.

a procedure of performing authenticated connection to the electric power meter based on the authentication information,

a procedure of receiving a measurement value related to an amount of electric power from the electric power meter, and

a procedure of transferring the measurement, value which is received from the electric power meter, to a destination that is different from the electric power meter,
45. The program according to (44), in which the computer is caused to perform

a procedure of receiving the measurement value, which is periodically transmitted to a first destination through the first pathway by the electric power meter that is connected after the authentication, through a second pathway that is different from the first pathway, and

a procedure of transferring the received measurement, value to a second destination that is different from the first destination, through a third pathway that is different from the first pathway and the second pathway.
46. The program according to (45) in which the computer is caused to perform

a procedure of storing the information for authenticating the electric power meter, which is acquired from the second destination through the third pathway, in a storage unit, and

a procedure of performing authenticated, connection, to the electric power meter using the authentication information that is stored in the storage unit.
47. The program according to (46), in which the computer is caused to perform

a procedure of acquiring the information for authenticating the electric power meter based on identification information on the communication apparatus when the communication apparatus is powered on, and

a procedure of performing the authenticated, connection to the electric power meter based on the acquired authentication information.

This application claims the benefit of earlier filing date and right, of priority to Japanese Patent Application No. 2014-226395, filed on Nov. 7, 2014, the contents of which is incorporated by reference herein in its entirety.

1. A communication apparatus comprising:
a reception unit that receives a measurement value related to an amount of electric power from an electric power meter; and
a transfer unit that transfers the measurement value which i3 received from the electric power meter, to a destination that is different from the electric power meter.

2. The communication apparatus according to claim 1,
wherein the reception unit receives the measurement value, which is periodically transmitted to a first destination through the first pathway, from the electric power meter through a second pathway that is different from the first pathway, and
wherein the transfer unit transfers the received measurement value to a second destination that is different from the first destination, through a third pathway that is different from the first pathway and the second pathway.

3. The communication apparatus according to claim 2, further comprising:
an apparatus information acquisition unit that acquires apparatus information on each electric power-related apparatus from a plurality of electric power-related apparatuses; and
a transmission unit that transmits the measurement value and the apparatus information to the second destination.

4. The communication apparatus according to claim 3,
wherein the plurality of electric power-related apparatuses include a load apparatus, an electricity storage apparatus, and an electric power generator, and
wherein the apparatus information includes at least any one of information on a driving state, information on consumption of electric power related to the load apparatus, information on electric power storage related to the electricity storage apparatus, and information on electric power generation related to the electric power generator.

5. The communication apparatus according to claim 3 or 4, further comprising:
a control information reception unit that receives electric power demand control information through the third pathway;
a determination unit that determines whether or not to perform electric power demand control that is based on the received demand control information;
a transmission unit that transmits availability information that is determined by the determination unit, to the second destination through the third pathway; and
a control unit that instructs the electric power-related apparatus to control at least any of a driving operation, consumption of electric power, electric power generation, and electric power storage, through a fourth pathway, based on the demand control information.

6. The communication apparatus according to claim 5,
wherein the demand control information is set based on the measurement value and the apparatus information.

7. The communication apparatus according to claim 6,
wherein the electric power-related apparatus includes at least any one of the load apparatus, the electricity storage apparatus, and the electric power generator, and
wherein the demand control information is set in such a manner that the larger at least any one of the electric power consumed by each load apparatus, a magnitude of an amount of electric power generated by the electric power generator, and an amount of charge in the electricity storage apparatus is, the larger a suppressed electric power use amount is.

8. The communication apparatus according to any one of claims 3 to 7,
wherein the communication apparatus has portability,
the communication apparatus further comprising:
a communication state detection unit that detects each of communication states in the second pathway communicating with the electric power meter, the third pathway communicating with the second destination, and a fourth pathway communicating with the electric power-related apparatus; and
an output unit that outputs the communication state.

9. The communication apparatus according to any one of claims 2 to 8, further comprising:
a communication unit that communicates with electric power-related apparatuses which include at least any one of the load apparatus, the electric power generator, and the electricity storage apparatus, which are installed in a predetermined site where an amount of consumption of electric power is measured by the electric power meter; and
a communication control unit that performs the communication with the electric power meter in a case where the communication with the electric power-related apparatus is established by the communication unit.

10. The communication apparatus according to any one of claims 2 to 9, further comprising:
a storage unit in which information for authenticating each of the electric power meter and the second destination is stored in advance; and
an authentication unit that authenticates each of the electric power meter and the second destination by using the authentication information.

11. The communication apparatus according to claim 10, further comprising:
an authentication information acquisition unit that acquires the information for authenticating the electric power meter from the second destination through the third pathway,
wherein the information for authenticating the electric power meter, which is acquired by the authentication information acquisition unit, is stored in the storage unit.

12. The communication apparatus according to any one of claims 2 to 11,
wherein the transfer unit performs transfer of the measurement value when the reception unit receives the measurement value from the electric power meter.

13. The communication apparatus according to any one of claims 2 to 12,
wherein the transfer unit determines a transfer timing of the measurement value based on at least one of a storage capacity of the communication apparatus, a processing load on the communication apparatus, a communication state of the third pathway, and a processing load on an apparatus that is the second destination.

14. A communication system comprising:
a communication apparatus; and
a server,
wherein the communication apparatus comprises
a reception unit that receives a measurement value related to an amount of electric power, which is periodically transmitted to a first destination through a first pathway, from an electric power meter through a second pathway that is different from the first pathway, and
a transfer unit that transfers the received measurement value to the server that is a second destination which is different from the first destination, through a third pathway that is different from the second pathway, and
wherein the server comprises
an information collection unit that collects the measurement value of the electric power meter, which is transferred from at least one communication apparatus.

15. A method of controlling a communication apparatus, performed by the communication apparatus, comprising:
receiving a measurement value related to an amount of electric power from an electric power meter, and
transferring the measurement value that is received from the electric power meter, to a destination that is different from the electric power meter.

16. A method of controlling a communication apparatus, performed by the communication apparatus, comprising:
receiving a measurement value related to an amount of electric power, which is periodically transmitted to a first destination through a first pathway, from an electric power meter through a second pathway that is different from the first pathway, and
transferring the received measurement value to a second destination that is different from the first destination, through a third pathway that i3 different from the second pathway.

17. A program for causing a computer to execute:
a procedure of receiving a measurement value related to an amount of electric power from an electric power meter; and
a procedure of transferring the measurement value that is received from the electric power meter, to a destination that is different from the electric power meter.

18. A program for causing a computer to execute:
a procedure of receiving a measurement value related to an amount of electric power, which is periodically transmitted to a first destination through a first pathway, from an electric power meter through a second pathway that is different from the first pathway; and
a procedure of transferring the received measurement value to a second destination that is different from the first destination, through a third pathway that is different from the second pathway.

19. A communication apparatus comprising:
an authentication information acquisition unit that acquires information for authenticating an electric power meter based on identification information of the own apparatus;
an authentication unit that per forms authenticated connection to the electric power meter based on the authentication information;
a reception unit that receives a measurement value related to an amount of electric power from the electric power meter; and
a transfer unit that transfers the measurement value which is received from the electric power meter, to a destination that is different from the electric power meter.

20. The communication apparatus according to claim 19,
wherein the reception unit receives the measurement value, which is periodically transmitted to a first destination through the first pathway to a first destination by the electric power meter that is connected after the authentication by the authentication unit, through a second pathway that is different from the first pathway, and
wherein the transfer unit transfers the received measurement value to a second destination that is different from the first destination, through a third pathway that is different from the first pathway and the second pathway.

21. The communication apparatus according to claim 20, further comprising:
a storage unit that stores the information for authenticating the electric power meter, which is acquired by the authentication information acquisition unit from the second destination through the third pathway,
wherein the authentication unit performs authenticated connection to the electric power meter using the authentication information that is stored in the storage unit.

22. The communication apparatus according to claim 21,
wherein the authentication information acquisition unit acquires the information for authenticating the electric power meter based on identification information of the own apparatus when the own apparatus is powered on, and
wherein the authentication unit performs the authenticated connection to the electric power meter based on the acquired authentication information.
